(19) United States
(12) Patent Application Publication
(10) Pub. No.: US 2025/0284037 A1
(43) Pub. Date: Sep. 11, 2025

(54) SYSTEMS AND PROCESSES FOR TEMPERATURE-TUNABLE METALENSES

(71) Applicant: BlueHalo, LLC, Northwest, AL (US)

(72) Inventors: Ekaterina Vladislavovna Poutrina, Huntsville, AL (US); Augustine Michael Urbas, Huntsville, AL (US); Dean P. Brown, Huntsville, AL (US)

(21) Appl. No.: 19/074,254

(22) Filed: Mar. 7, 2025

Related U.S. Application Data
(60) Provisional application No. 63/563,069, filed on Mar. 8, 2024.
(60) Provisional application No. 63/684,768, filed on Aug. 19, 2024.

(51) Int. Cl. G02B 3/08; G02B 3/00; G02B 5/18; G02B 27/00

(52) U.S. Cl. CPC G02B 3/08; G02B 5/1809; G02B 27/0012; G02B 2003/0093

(57) ABSTRACT

A metalens for focusing light is described. The metalens includes a library of elements for varying the propagating phase of the focusing light over at least a 2π radians range, where the library of elements is arranged in a sub-wavelength pattern that defines spacings between the elements. Each spacing exhibiting temperature-dependent spacing changes within a temperature range and each element in the library of elements includes: a refractive index exhibiting a temperature-dependency within the temperature range, a shape exhibiting a temperature-dependency within the temperature range, and a size exhibiting a temperature-dependency within the temperature range. The metalens also includes a phase profile defined by a combination of the refractive index, shape, and size of each element in the library, and the sub-wavelength pattern of the library of elements. The metalens also includes a focal length defined by the phase profile, the focal length exhibiting a temperature-dependency within the temperature range.

### CROSS REFERENCE TO RELATED APPLICATIONS

This application claims priority to and benefit of U.S. Provisional Patent Application No. 63/563,069, filed on Mar. 8, 2024, and U.S. Provisional Patent Application No. 63/684,768, filed on Aug. 19, 2024, the entire disclosure of each of which is hereby incorporated by reference.

### FIELD OF TECHNOLOGY

The present disclosure relates generally to lenses and, more particularly, to metalenses.

### BACKGROUND

Metalens is a type of flat optical lens that uses nanostructured surfaces, known as metasurfaces, to manipulate light at a subwavelength scale. Unlike traditional lenses, which rely on curved glass or plastic to bend light, metalenses use nanoscale patterns of dielectric or metallic elements to control phase, amplitude, and polarization with high precision. In traditional lenses, thermal expansion and thermal contraction can result in shifting of focal positions of lenses, which can be problematic for certain applications. Metalenses are not immune to this issue.

### SUMMARY

The subject matter described herein relates to metalenses and to processes for manufacturing the same. More specifically, it relates to metalenses for focusing light having a center wavelength and a propagating phase. A metalens may include a library of elements for varying the propagating phase of the focusing light over a range of at least 2π radians, where the library of elements is arranged in a sub-wavelength pattern that defines spacings between the elements. Each spacing exhibiting temperature-dependent spacing changes within temperature range and where each element in the library of elements includes: a refractive index exhibiting a temperature-dependent refractive-index change within the temperature range, a shape exhibiting a temperature-dependent shape change within the temperature range, and a size exhibiting a temperature-dependent size change within the temperature range. The metalens also includes a phase profile defined by a combination of the refractive index, shape, and size of each element in the library of elements, and the sub-wavelength pattern of the library of elements. The metalens also includes a focal length defined by the phase profile, the focal length exhibiting temperature-dependent focal-length changes within the temperature range.

The present disclosure also teaches processes for manufacturing metalenses. The process may include obtaining candidate elements with each set of elements configured to vary a propagating phase of refracted light over a range of at least 2π radians, measuring a refractive index change of each element over the operating temperature range, measuring a shape change of each element over the operating temperature range, measuring a size change of each element over the operating temperature range, and measuring a spacing change between elements over the operating temperature range for elements arranged within a sub-wavelength pattern. The process further includes in a first step, calculating a focal length shift of the metalens caused by the measured refractive index change over the operating temperature range, in a second step, calculating the focal length shift of the metalens caused by the measured shape change over the operating temperature range, in a third step, calculating the focal length shift of the metalens caused by the measured size change over the operating temperature range, and in a fourth step, calculating the focal length shift of the metalens caused by the measured spacing change over the operating temperature range. Additionally, the process includes determining a combination of elements that causes the focal length shift of the metalens to change in a predictable way over the operating temperature range, where the determination is based at least on the first, second, third, and fourth step, and finally selecting a library of elements that form the metalens based on the determined combination.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a diagram illustrating thermally induced variations in lens phase (ϕ) profiles and housing positions, in accordance with some embodiments.

FIG. 2 is a diagram illustrating optical path convergence in a Fresnel lens, in accordance with some embodiments.

FIG. 3 is a chart illustrating a linear ϕ dependence as a function of element size for a metalens library with a positive linear slope, in accordance with some embodiments.

FIG. 4 is a chart illustrating a convex ϕ profile associated with the chart of FIG. 3 for an original convex ϕ profile (solid line) and a modified ϕ profile (broken line) produced by an increase in temperature (T), in accordance with some embodiments.

FIG. 5 is a chart illustrating a linear ϕ dependence as a function of element size for a metalens library with a negative linear slope, in accordance with some embodiments.

FIG. 6 is a chart illustrating a convex ϕ profile associated with the chart of FIG. 5 for an original convex ϕ profile (solid line) and a modified ϕ profile (broken line) produced by an increase in T (meaning, +ΔT), in accordance with some embodiments.

FIG. 7 is a chart illustrating ϕ dependence as a function of element size for a metalens library as a positive non-linear concave-up increasing function, in accordance with some embodiments.

FIG. 8 is a chart illustrating a convex ϕ profile associated with the chart of FIG. 7 for an original convex ϕ profile (solid line) and a modified ϕ profile (broken line) produced by +ΔT, in accordance with some embodiments.

FIG. 9 is a chart illustrating ϕ dependence as a function of element size for a metalens library as a positive non-linear concave-down increasing function, in accordance with some embodiments.

FIG. 10 is a chart illustrating a convex ϕ profile associated with the chart of FIG. 9 for an original convex ϕ profile (solid line) and a modified ϕ profile (broken line) produced by +ΔT, in accordance with some embodiments.

FIG. 11 is a chart illustrating ϕ dependence as a function of element size for a metalens library as a negative non-linear concave-down decreasing slope, in accordance with some embodiments.

FIG. 12 is a chart illustrating a convex ϕ profile associated with the chart of FIG. 11 for an original convex ϕ profile (solid line) and a modified ϕ profile (broken line) produced by +ΔT, in accordance with some embodiments.

FIG. 13 is a chart illustrating ϕ dependence as a function of element size for a metalens library as a negative non-linear concave-up decreasing slope, in accordance with some embodiments.

FIG. 14 is a chart illustrating a convex ϕ profile associated with the chart of FIG. 12 for an original convex ϕ profile (solid line) and a modified ϕ profile (broken line) produced by +ΔT, in accordance with some embodiments.

FIG. 15 is a chart illustrating a focal shift for a regular silicon (Si) refractive lens, with the focal shift varying inversely and linearly as a function of lens diameter (i.e., a linear negative slope) in response to +ΔT from 293 Kelvin (K) to 450 K, in accordance with some embodiments.

FIG. 16 is a chart illustrating a focal shift for a silicon Fresnel lens with an f-number of f/10, with the focal shift varying directly and linearly as a function of lens diameter (meaning, a linear positive slope) in response to the same +ΔT from 293 K to 450 K, in accordance with some embodiments.

FIG. 17 is a chart illustrating different focal shifts as a function of library choice for a controlled +ΔT from 293 K to 450 K, in accordance with some embodiments.

FIG. 18 is a chart illustrating an acceptable range in a library of pillar nanoelements for one of the metalens data shown in FIG. 17, in accordance with some embodiments.

FIG. 19 is a chart illustrating an acceptable range in a library of pillar nanoelements for another of the metalens data shown in FIG. 17, in accordance with some embodiments.

FIG. 20A is a chart illustrating a T-dependent family of curves for different pillar diameters, in accordance with some embodiments.

FIG. 20B shows an enlarged portion of the chart of FIG. 20A, in accordance with some embodiments.

FIG. 21 is a chart illustrating focal shift as a function of T (both increasing and decreasing from 293K) for a metalens with 1 millimeter (mm) diameter, an f-number of three (f/3), a matched wavefront at 4 micrometers (μm), and constructed with pillars having different maximum pillar diameters, in accordance with some embodiments.

FIG. 22 is a chart illustrating focal shift as a function of T (both increasing (+ΔT) and decreasing (−ΔT) from 293 K) for a metalens with 5 mm diameter, f/15, matched wavefront at 4 μm, and constructed with pillars having different maximum pillar diameters, in accordance with some embodiments.

FIG. 23 is a chart illustrating focal shift as a function of both +ΔT and −ΔT from 293 K for a metalens with 5 mm diameter, f/12, matched wavefront at 4 μm, a pitch of 1.5 μm, and constructed with pillars having different maximum pillar diameters and spanning a ϕ range of 4×, in accordance with some embodiments.

FIG. 24 is a chart illustrating focal shift as a function of both +ΔT and −ΔT from 293K for a metalens with 5 mm diameter, f/11, matched wavefront at 4 μm, a pitch of 1.5 μm, and constructed with pillars having different maximum pillar diameters and spanning a ϕ range of 4×, in accordance with some embodiments.

FIG. 25 is a chart illustrating focal shift as a function of both +ΔT and −ΔT from 293K for a metalens with 5 mm diameter, f/10, matched wavefront at 4 μm, a pitch of 1.5 μm, and constructed with pillars having different maximum pillar diameters and spanning a ø range of 4×, in accordance with some embodiments.

FIG. 26 is a chart illustrating focal shift as a function of both +ΔT and −ΔT from 293K for a metalens with 5 mm diameter, f/10, matched wavefront at 4 μm, a pitch of 1.6 μm, and constructed with pillars having two (2) different maximum pillar diameters and spanning a ϕ range of 4×, in accordance with some embodiments.

FIG. 27 is a chart illustrating focal shift as a function of both +ΔT and −ΔT from 293K for a metalens with 5 mm diameter, f/10, matched wavefront at 4 μm, a pitch of 1.6 μm, and constructed with pillars having two (2) different maximum pillar diameters and spanning a ϕ range of 2×, in accordance with some embodiments.

FIG. 28 is a chart illustrating an acceptable range in a library of pillar nanoelements having a maximum pillar diameter of 890 nm and spanning a ø range of 2π (“Set 890”) for the metalens data shown in FIG. 27, in accordance with some embodiments.

FIG. 29 is a chart illustrating an acceptable range in a library of pillar nanoelements having a maximum pillar diameter of 1440 nm and spanning a ø range of 2π (“Set 1440”) for the metalens data shown in FIG. 27, in accordance with some embodiments.

FIG. 30 is a diagram showing a ϕ profile for an aperture that includes 33 Fresnel aperture zones, in accordance with some embodiments.

FIG. 31 is a chart illustrating focal shift as a function of T for different number of Fresnel zones within an aperture for a metalens constructed from Set 890, in accordance with some embodiments.

FIG. 32A is a flowchart showing process steps for manufacturing a metalens, in accordance with some embodiments.

FIG. 32B is a flowchart showing additional process steps for manufacturing the metalens, in accordance with some embodiments.

### DETAILED DESCRIPTION OF THE EMBODIMENTS

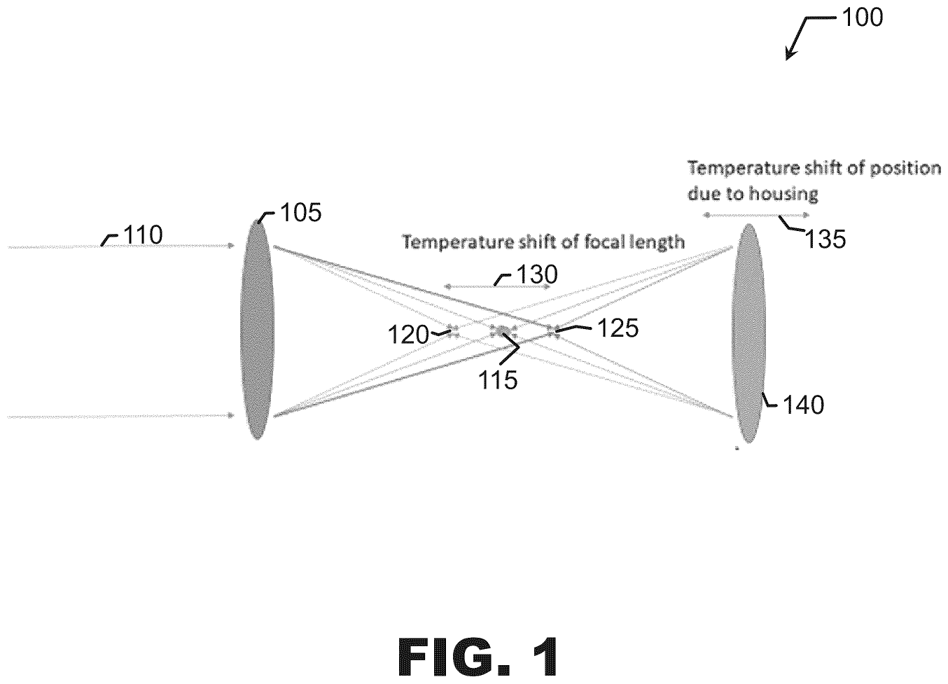

Optical systems that operate over a wide range of temperatures can experience thermal contraction and thermal expansion. FIG. 1 is a diagram 100 illustrating thermally induced variations in lens phase profiles and housing positions. Specifically, shown in FIG. 1 is a lens 105 with incoming light 110 being focused at different focal positions 115, 120, 125, as temperature (T) (e.g., the ambient T) shifts. FIG. 1 also shows a shift 135 in a housing 140, which is also dependent on shifts in T. As one can appreciate, the focal position 115, 120, 125 is affected by the T-dependencies of both the lens 105 and the housing 140.

The thermal contraction and thermal expansion can lead to changes in physical properties of a lens, including possible changes to the refractive index. Other components (such as housing and mounts) are also susceptible to thermal expansion and thermal contraction, thereby exacerbating thermal effects above and beyond those experienced by the lens itself. Furthermore, different materials experience differing degrees of thermal contraction or thermal expansion. Moreover, even within the same T range (ΔT), some materials may experience a thermal expansion, while other materials experience a thermal contraction. Additionally, the degree of contraction and expansion can also vary based on the starting T. For example, a particular material may experience a greater expansion going from 5 degrees Celsius (C) to 15° C. than it does from 200° C. to 210° C., even though both cover the same ΔT of +10° C.

As one can readily appreciate, all of these confounding factors affect a focal length (or a focal position) of a lens in unpredictable ways. Furthermore, T-dependent effects on focal position can also vary based on wavelength (λ) of light being transmitted through the lens, thereby adding yet another layer of complexity.

This disclosure teaches two different types of systems and their corresponding manufacturing processes based on thermal expansion and thermal contraction. First, this disclosure teaches metalenses that have relatively T-immune responses to large fluctuations in T. These types of systems are useful for maintaining a fixed focal distance over a wide ΔT, such as environments in outer space. Second, this disclosure teaches metalenses that have T-controllable responses in which one can selectively adjust a focal distance by changing T. In other words, rather than adjusting focal distances mechanically, the metalenses described herein permit a user to adjust T upwardly or downwardly to increase or decrease the focal distances.

More specifically, for the first type of system (a system that is relatively immune to fluctuations in T), different elements (and sub-wavelength patterns of those elements) are chosen so that, within a particular ΔT, thermal effects experienced by those elements counteract each other to maintain a relatively T-insensitive focal position. For example, specific elements of a metalens are chosen so that T-dependent refractive-index changes (d_{refractive_index}(T)), T-dependent shape changes (dₛₕₐₚₑ(T)), T-dependent size changes (d_{size}(T)), T-dependent spacing changes (d_{spacing}(T)), and T-dependent phase-profile changes (d_{phase_profile}(T)) balance each other in such a manner that the net T-dependent focal-length changes (d_{focal_length}(T)) are insignificant over the ΔT.

For the second type of system (a system where focal distance is controllable with T), different metalens elements are chosen so that a combination of d_{refractive_index}(T), dₛₕₐₚₑ(T), d_{size}(T), d_{spacing}(T)), and d_{phase_profile}(T) act in concert to make d_{focal_length}(T) tunable to a desired focal length by changing T.

Ultimately, the disclosed systems and processes provide a T-tunable metalens, which can increase, decrease, or maintain its focal distance over a known ΔT through careful selection of different metalens elements.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

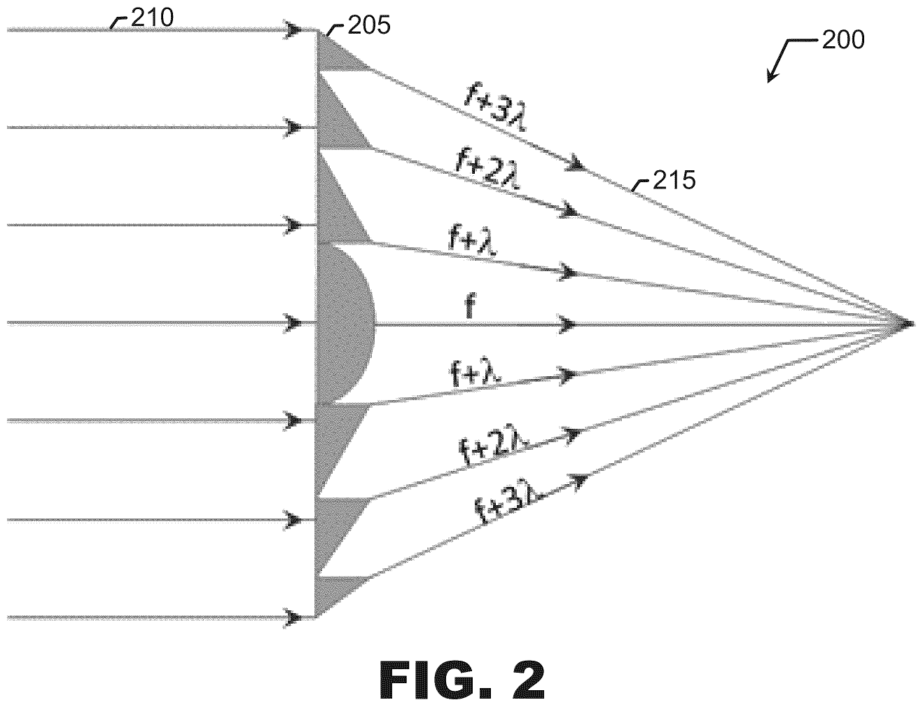

By way of background, FIG. 2 is a diagram 200 illustrating optical path convergence in a Fresnel lens 205. As shown in FIG. 2, incoming light 210 becomes focused 215 by the Fresnel lens 205. Insofar as Fresnel lenses are well known to those having ordinary skill in the art, only a truncated discussion of Fresnel lenses is provided with reference to FIG. 2. Specifically, unlike conventional refractive lenses, which are thick and curved, Fresnel lenses are divided into a series of concentric grooves (designated as “Fresnel zones”), each of which refract incoming light to different degrees, thereby collectively behaving as a single conventional refractive lens but with a much thinner profile and, consequently, lesser material and lesser weight.

Diffractive lenses (not shown) use principles of diffraction (rather than refraction) to manipulate light waves. Carefully designed patterns of surface-relief structures introduce controlled phase shifts in incoming light waves, which lead to interference patterns that shape the behavior of light. These interference patterns permit focusing, shaping, and dispersing of light in a controlled manner.

A metalens (also known as a metasurface or a metasurface lens) uses nanoscale elements (also known as meta-atoms, meta-elements, or simply elements) that have sizes that are smaller than the wavelength (λ) of light that the metalens seeks to focus. The elements are also arranged in a periodic fashion with the periodicity also being sub-λ. A combination of the sub-λ-size and the sub-λ-periodicity permits precise manipulation of light by altering both amplitude and phase (ϕ) at each point on the metalens. The @ profile bears a similarity to that of a Fresnel lens (200, FIG. 2). However, unlike the Fresnel lens, the metalens manipulates light by strategic arrangement of elements with varying sizes and shapes (also known as a library of elements, library set, or simply a library) that enable ϕ variations that cover a range of at least 2π when sweeping through the nanoelements within that library. If a particular library offers ϕ variations that exceed 2π, then a subset of elements from that particular library (meaning, a subset of the collection of elements with a given size and a given shape) can be used to construct a desired metalens.

Refractive lenses and diffractive lenses exhibit different T-dependencies. Focal shifts in refractive lenses are predominantly attributed to T-induced changes in refractive indices and T-induced expansion (or contraction) of the lens material. By comparison, focal shifts in diffractive lenses are predominantly influenced by T-dependent ϕ variations that result from lateral thermal expansion.

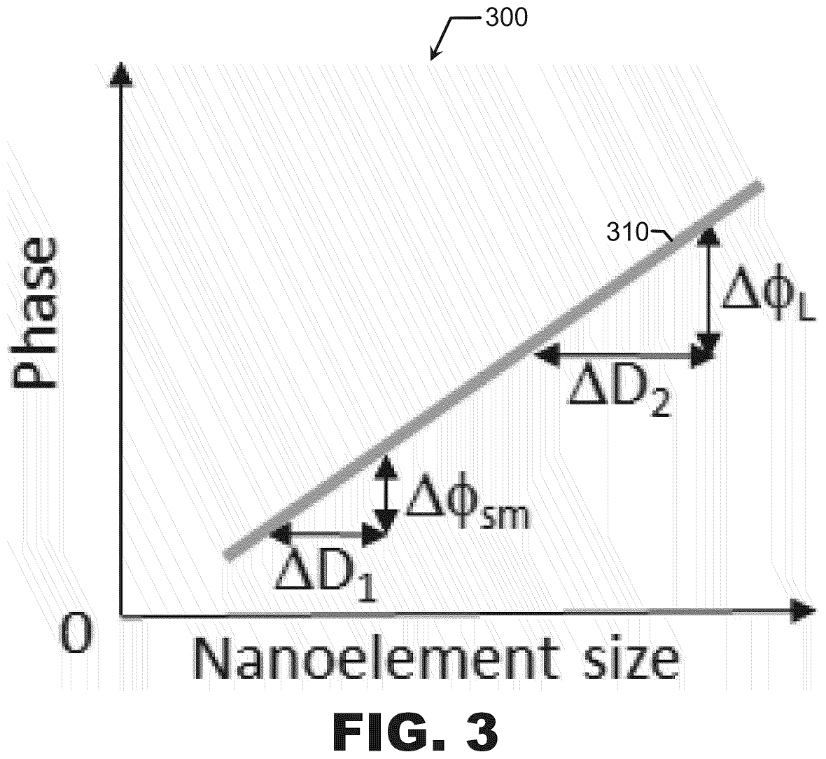

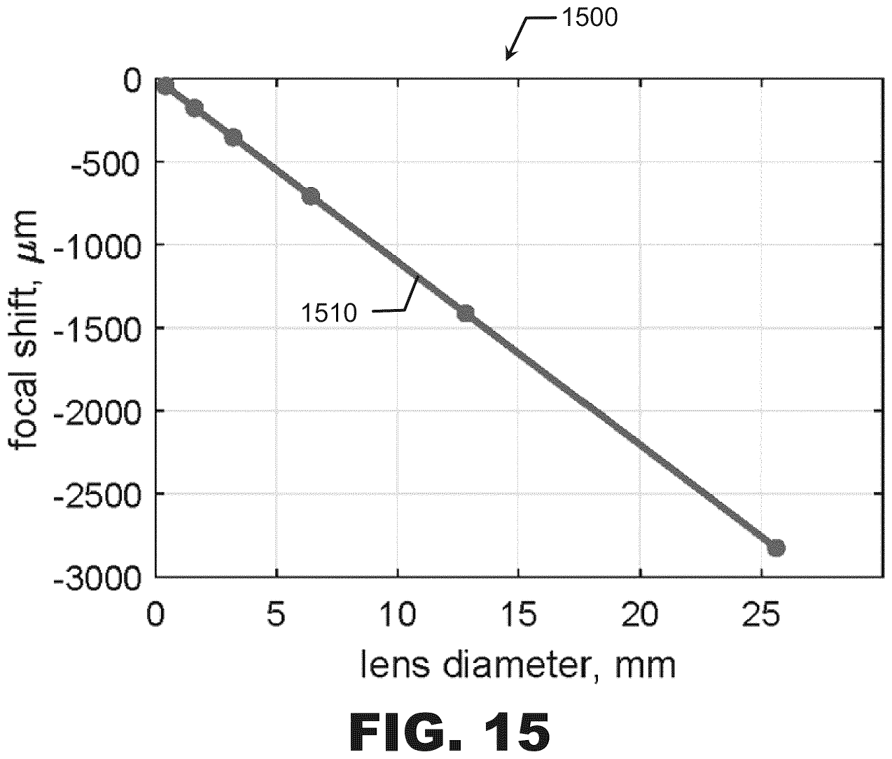

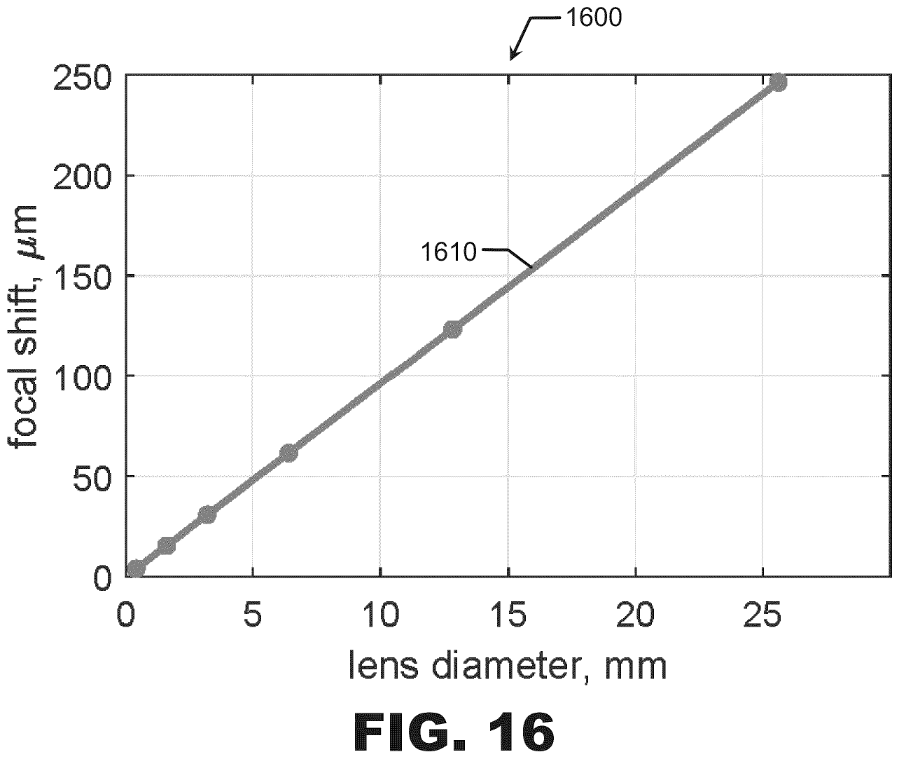

For metalenses, it is possible to control T-induced focal shifts by careful selection of the library when constructing the metalens. FIGS. 3 through 32B demonstrate properties of different libraries, along with behaviors of metalenses that are constructed from different libraries.

With this in mind, attention is turned to FIG. 3, which is a chart 300 illustrating a linear phase dependence as a function of element size for a metalens library with a positive linear slope 310. As shown in FIG. 3, as the nanoelement size increases (e.g., an increase in a diameter (+ΔD) of a nanoelement), there is a corresponding linear increase in ϕ (the change being designated as +46). For small +ΔD₁, there is a correspondingly small +Δϕₛₘ, while a larger +ΔD₂ produces a correspondingly larger +Δϕ_{L}.

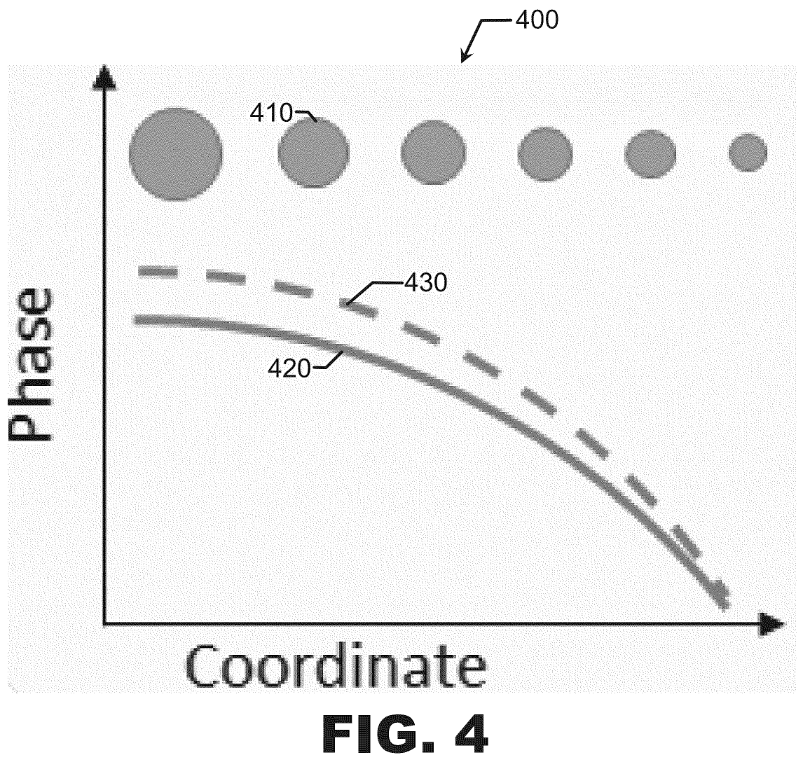

FIG. 4 is a chart 400 illustrating a convex ϕ profile associated with chart 300 of FIG. 3 for different element sizes 410 (showing elements decreasing in size with increasing coordinate from left coordinate to right coordinate). The term coordinate as used herein refers to the distance from the center of the metalens. Accordingly, FIGS. 4, 6, 8, 10, 12, and 14 discussed below depict (one side of) the phase imposed by the metalens on the incident beam as it propagates through, plotted as a function of this distance from the center to the edge of the metalens. In these FIGS., only right half of the imposed phase profile is shown, with the other half being symmetric about the vertical axis. The zero coordinate corresponding to the center of the metalens. FIG. 4 shows both an original convex ϕ profile (solid line 420) and a modified ϕ profile (broken line 430) produced by an increase in T. Thus, as shown in FIG. 4, as coordinate increases, the size 410 of the element decreases (going from larger to smaller). Because a larger +ΔD corresponds to a larger +40, a rise in T produces greater increases in ϕ in areas with larger elements than in areas with smaller elements and, consequently, a more convex modified ϕ profile 430 compared to an original ϕ profile 420.

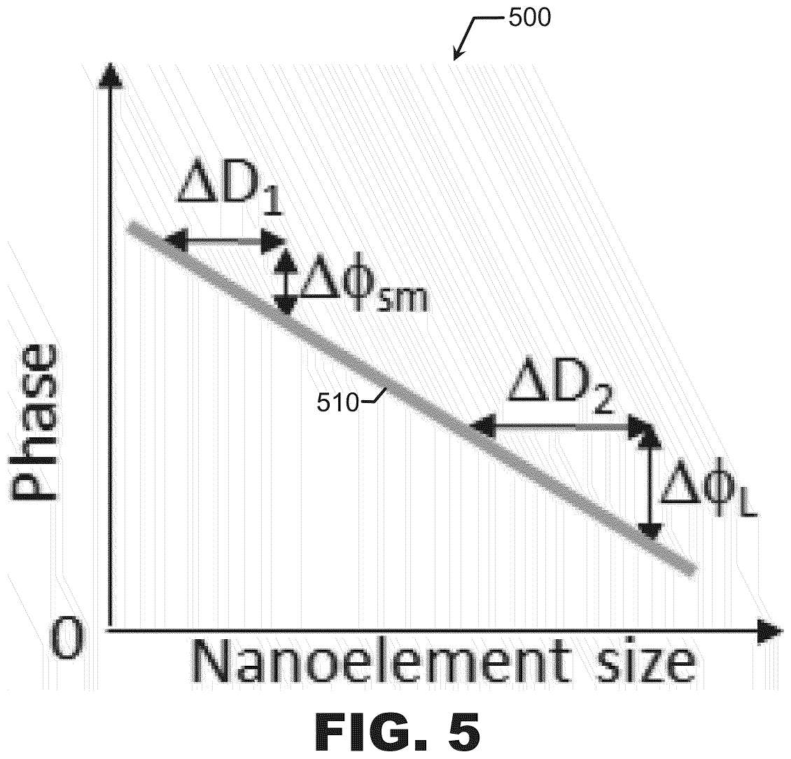

In contrast to FIG. 3, shown in FIG. 5 is a chart 500 illustrating a linear ϕ dependence as a function of element size for a metalens library with a negative linear slope 510. For FIG. 5, as nanoelement size increases (e.g., an increase in a diameter (+ΔD) of a nanoelement), there is a corresponding −Δϕ. For small +ΔD₁, there is a correspondingly small −Δϕₛₘ, while a larger +ΔD₂ produces a correspondingly larger −Δϕ_{L}.

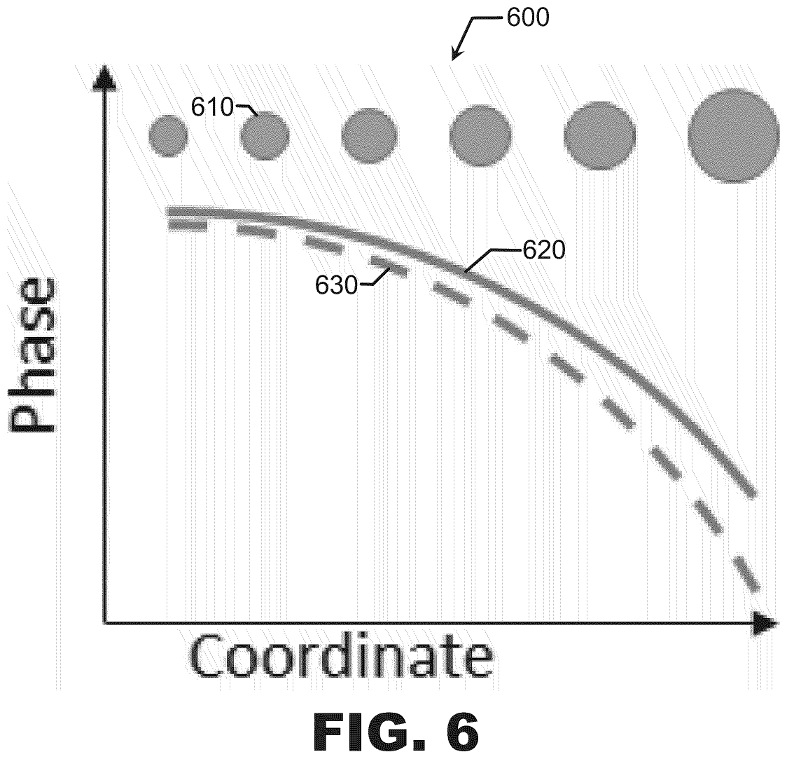

FIG. 6 is a chart 600 illustrating a convex ϕ profile associated with the chart 500 of FIG. 5 for different element sizes 610 (showing elements increasing in size with increasing coordinate). FIG. 6 shows both an original convex ϕ profile (solid line 620) and a modified ϕ profile (broken line 630) produced by an increase in T. Unlike FIG. 4, as coordinate increases in FIG. 6, the size 610 of the element increases (going from smaller to larger). Because a larger +ΔD corresponds to a larger −Δϕ, a rise in T produces greater decrease in ϕ in areas with larger elements than in areas with smaller elements. This, again, produces a more convex modified ϕ profile 630 compared to an original ϕ profile 620 (similar to FIG. 4).

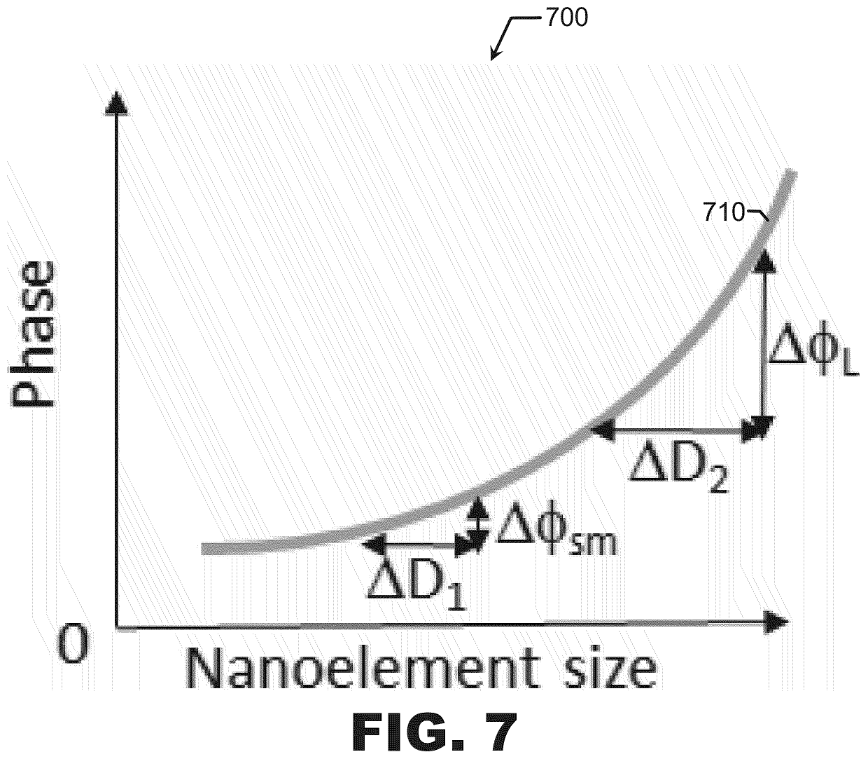

In contrast to FIG. 3, shown in FIG. 7 is a chart 700 illustrating ϕ dependence as a function of element size for a metalens library as a positive non-linear concave-up increasing slope 710. For FIG. 7, with +ΔD there is a corresponding non-linear +Δϕ. For small +ΔD₁, there is small +Δϕₛₘ, but a larger +ΔD₂ produces a +Δϕ_{L}, that is much larger than the +Δϕ_{L} in the chart 300 of FIG. 3.

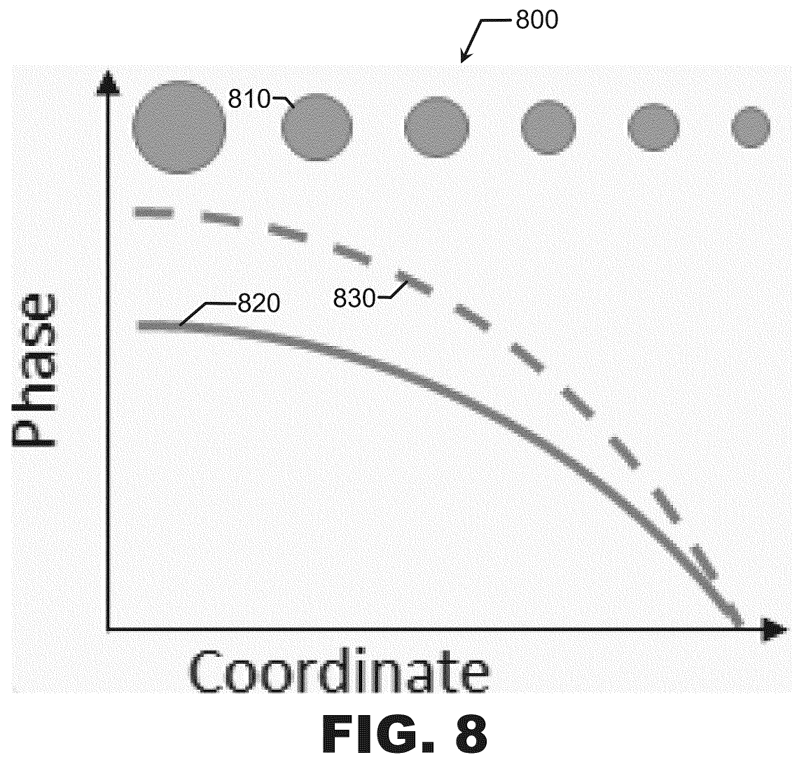

FIG. 8 is a chart 800 illustrating a convex ϕ profile associated with the chart 700 of FIG. 7 for different element sizes 810 (showing elements decreasing in size with increasing coordinate). FIG. 8 shows both an original convex ϕ profile (solid line 820) and a modified ϕ profile (broken line 830) produced by an increase in T. Similar to FIG. 4, as coordinate increases in FIG. 8, the size 810 of the element decreases (going from larger to smaller). Because a larger +ΔD corresponds to a disproportionately larger +Δϕ than in FIG. 4, a rise in T produces an even greater increase in ϕ in areas with larger elements than in areas with smaller elements. This produces an even more convex modified ϕ profile 830 compared to an original ϕ profile 820—i.e., a larger effect than what is shown in FIG. 4.

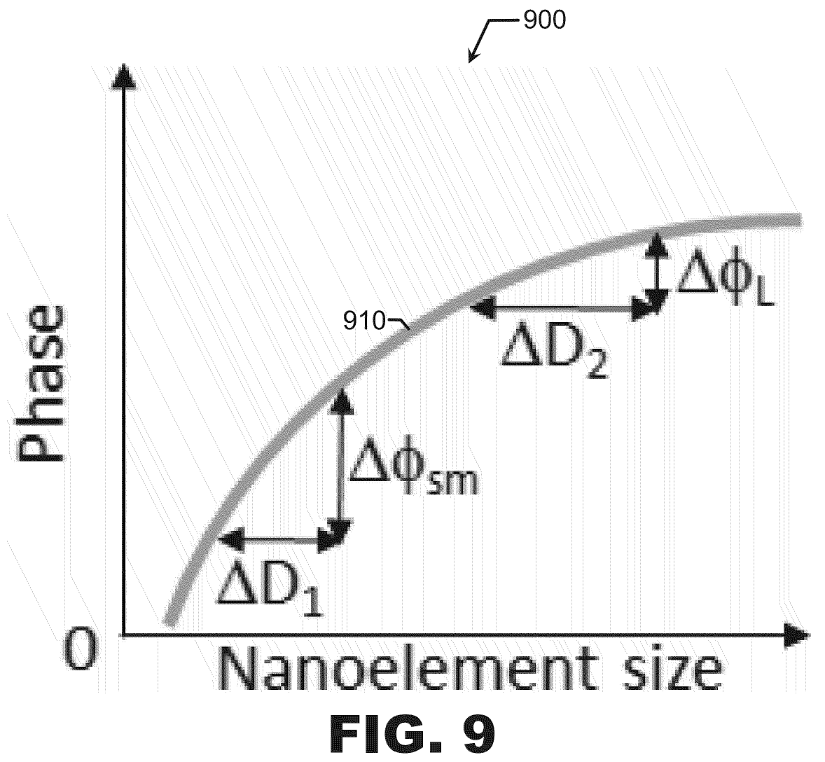

In contrast to FIG. 7, shown in FIG. 9 is a chart 900 illustrating ϕ dependence as a function of element size for a metalens library as a positive non-linear concave-down increasing slope 910. For FIG. 9, with +ΔD, there is a corresponding non-linear +Δϕ. For large +ΔD₁, there is small +Δϕₛₘ. A larger +ΔD₂ produces a +Δϕ_{L} that is much smaller than the +Δϕ_{L} in the charts 300, 700 of either FIG. 3 or FIG. 7.

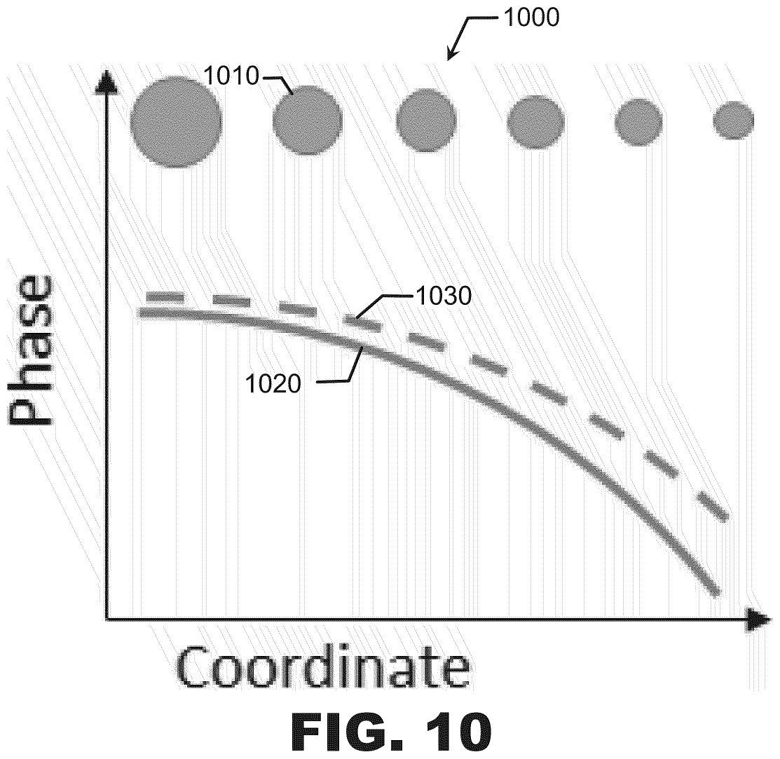

FIG. 10 is a chart 1000 illustrating a convex ϕ profile associated with the chart 900 of FIG. 9 for different element sizes 1010 (showing elements decreasing in size with increasing coordinate). FIG. 10 shows both an original convex ϕ profile (solid line 1020) and a modified ϕ profile (broken line 1030) produced by an increase in T. Similar to FIGS. 4 and 8, as coordinate increases in FIG. 10, the size 1010 of the element decreases (going from larger to smaller). Because a larger +ΔD corresponds to a disproportionately smaller +Δϕ than in either FIG. 4 or FIG. 8, a rise in T produces an even smaller increase in ϕ in areas with larger elements than in areas with smaller elements. This produces a less convex modified ϕ profile 1030 compared to an original ϕ profile 1020—i.e., a much smaller effect than what is shown in either FIG. 4 or FIG. 8.

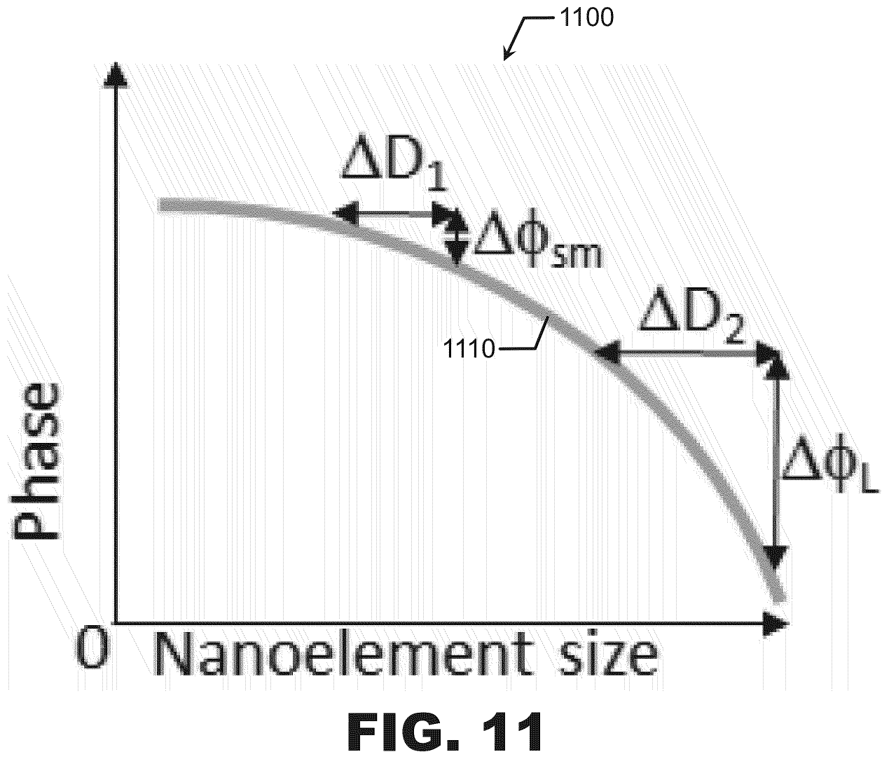

In contrast to FIG. 5, shown in FIG. 11 is a chart 1100 illustrating ϕ dependence as a function of element size for a metalens library as a negative non-linear concave-down decreasing slope 1110. For FIG. 11, with +ΔD, there is a corresponding non-linear −Δϕ. For small +ΔD₁, there is small −Δϕₛₘ. A larger +ΔD₂ produces a disproportionately larger −Δϕ₂—i.e., much larger than the −Δϕ_{L} in the chart 500 of FIG. 5.

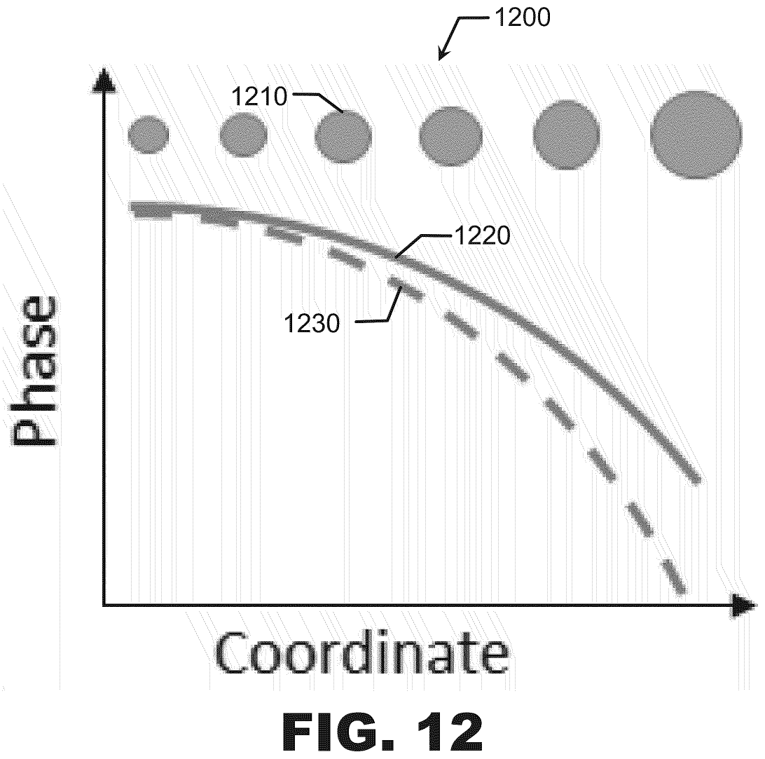

FIG. 12 is a chart 1200 illustrating a convex ϕ profile associated with the chart 1100 of FIG. 11 for different element sizes 1210 (showing elements increasing in size with increasing coordinate). FIG. 12 shows both an original convex ϕ profile (solid line 1220) and a modified ϕ profile (broken line 1230) produced by an increase in T. As coordinate increases in FIG. 12, the size 1210 of the element increases (going from smaller to larger). Because a larger +ΔD corresponds to a disproportionately larger −Δϕ (in comparison to FIG. 5), a rise in T produces an even larger decrease in ϕ in areas with larger elements than in areas with smaller elements. This produces a more convex modified ϕ profile 1230 compared to an original ϕ profile 1220—i.e., a much larger effect than what is shown in FIG. 6.

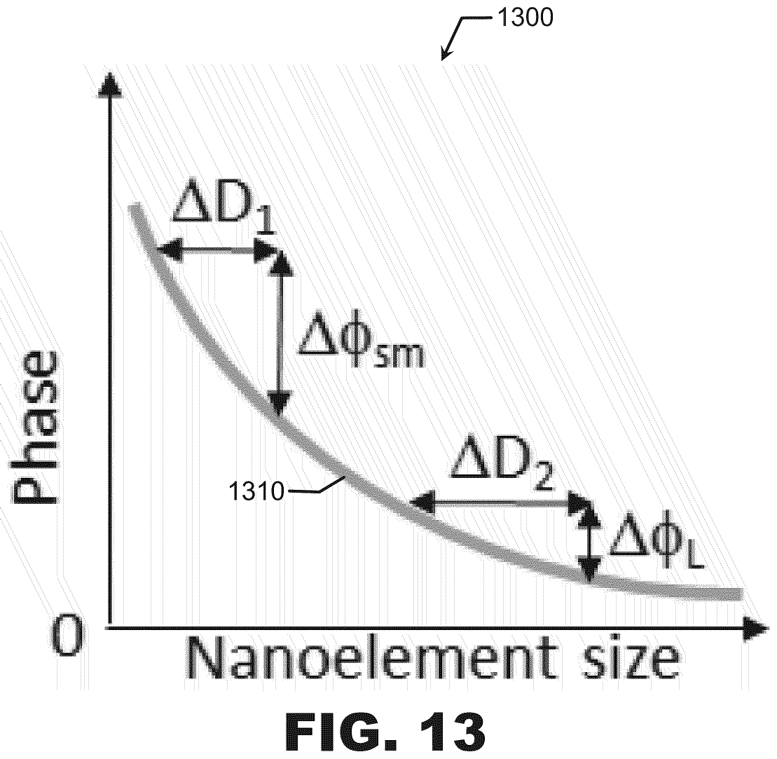

In contrast to FIG. 11, shown in FIG. 13 is a chart 1300 illustrating ϕ dependence as a function of element size for a metalens library as a negative non-linear concave-up decreasing slope 1310. For FIG. 13, with +ΔD there is a corresponding non-linear −Δϕ. For small +ΔD₁, there is large +Δϕₛₘ. A larger +ΔD₂ produces a smaller +Δϕ_{L} (much smaller than the +Δϕ_{L} in the charts 500, 1100 of either FIG. 5 or FIG. 11).

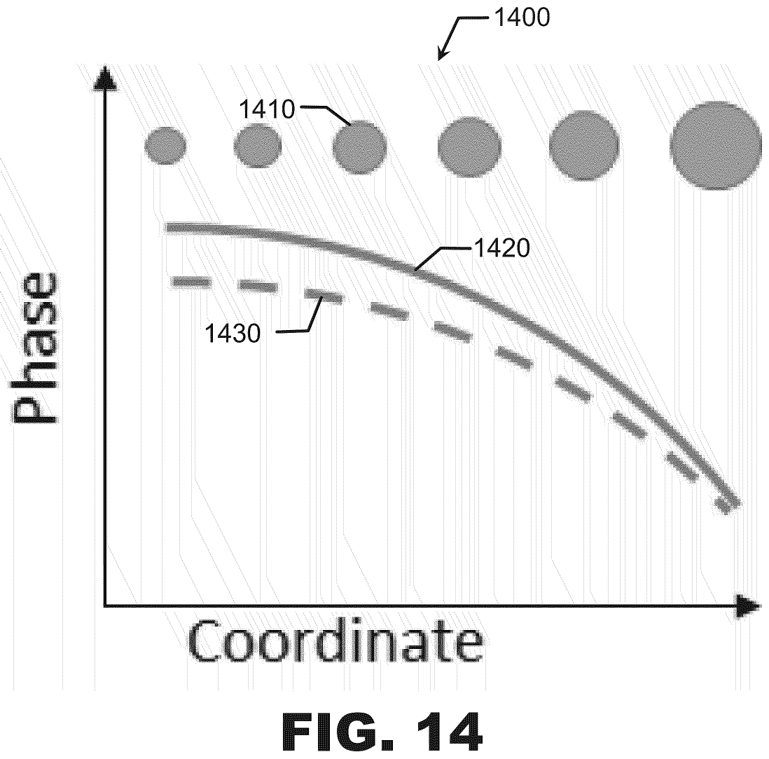

FIG. 14 is a chart 1400 illustrating a convex ϕ profile associated with the chart 1300 of FIG. 13 for different element sizes 1310 (showing elements increasing in size with increasing coordinate). FIG. 14 shows both an original convex ϕ profile (solid line 1420) and a modified ϕ profile (broken line 1430) produced by an increase in T. As coordinate increases in FIG. 14, the size 1410 of the element increases (going from smaller to larger). Because a larger +ΔD corresponds to a disproportionately smaller +Δϕ, a rise in T produces a smaller decrease in ϕ in areas with larger elements than in areas with smaller elements. This produces a less convex modified ϕ profile 1430 compared to an original ϕ profile 1420—i.e., a much smaller effect than what is shown in either FIG. 6 or FIG. 12.

With knowledge of how curvature affects T responses of metalens elements, it is possible to design and construct metalenses that have tunable or controllable T responses by carefully selecting the libraries from which the metalenses are constructed. In other words, upon determining how a particular library behaves in relation to temperature changes (e.g., linearly increasing slope, linearly decreasing slope, non-linearly concave-upward increasing slope, non-linearly concave-upward decreasing slope, non-linearly concave-downward increasing slope, non-linearly concave-downward decreasing slope, increasing convexity, decreasing convexity, etc.), one can determine from the interplay of thermally-induced distortions, thermally-induced refractive index variations, and thermally-induced lateral expansions (or contractions) how a particular phase profile of a metalens will be impacted as T increases or decreases. From that determined interplay, a metalens with known T-related responses can be constructed. For example, from the determined interplay, one can construct a metalens that is largely immune to T fluctuations within a particular ΔT, or one can construct a metalens that is tunable to T within that same ΔT.

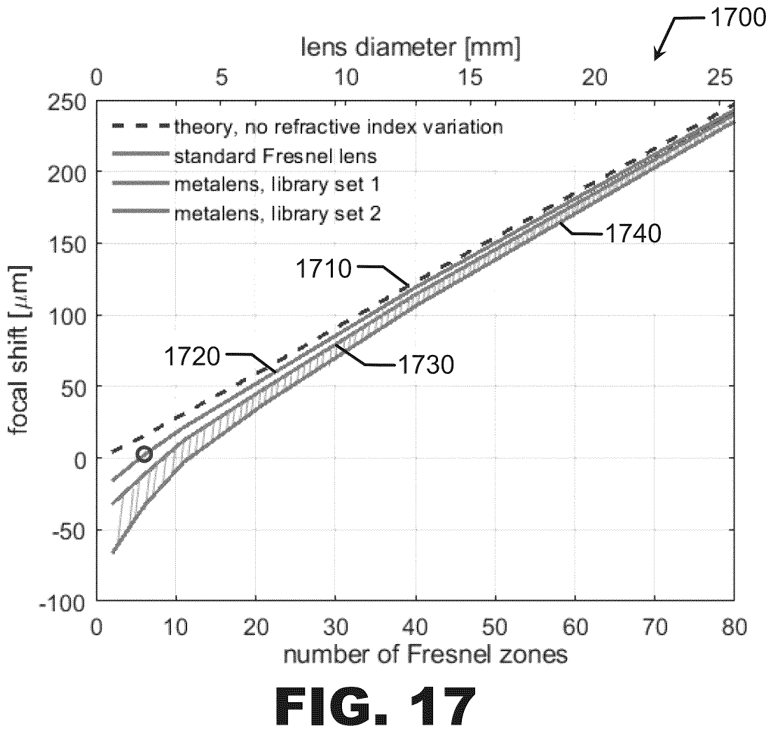

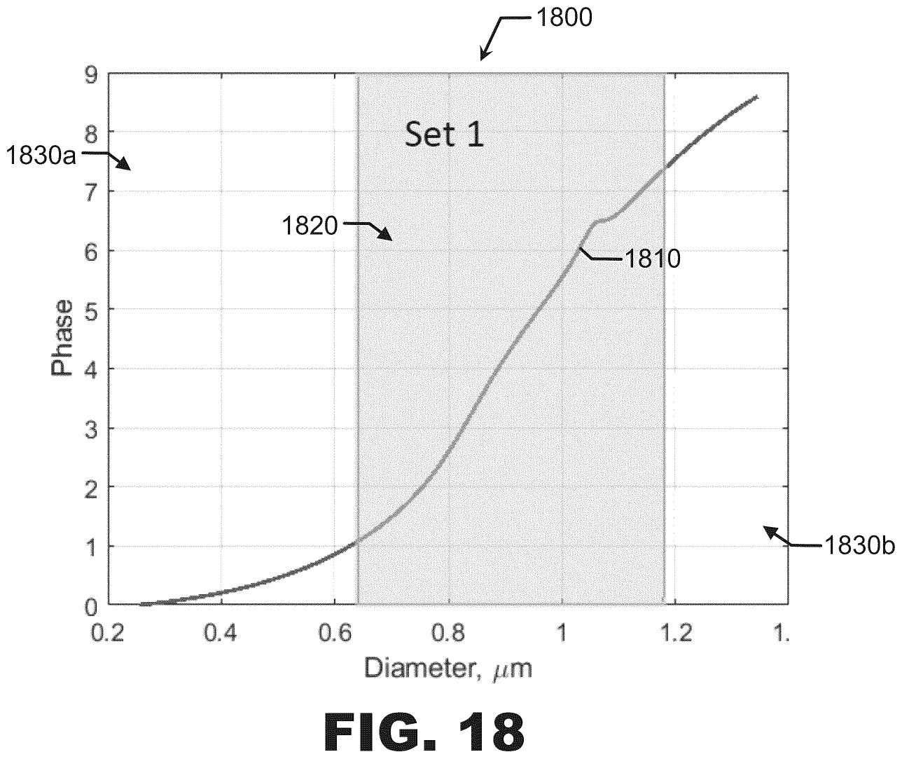

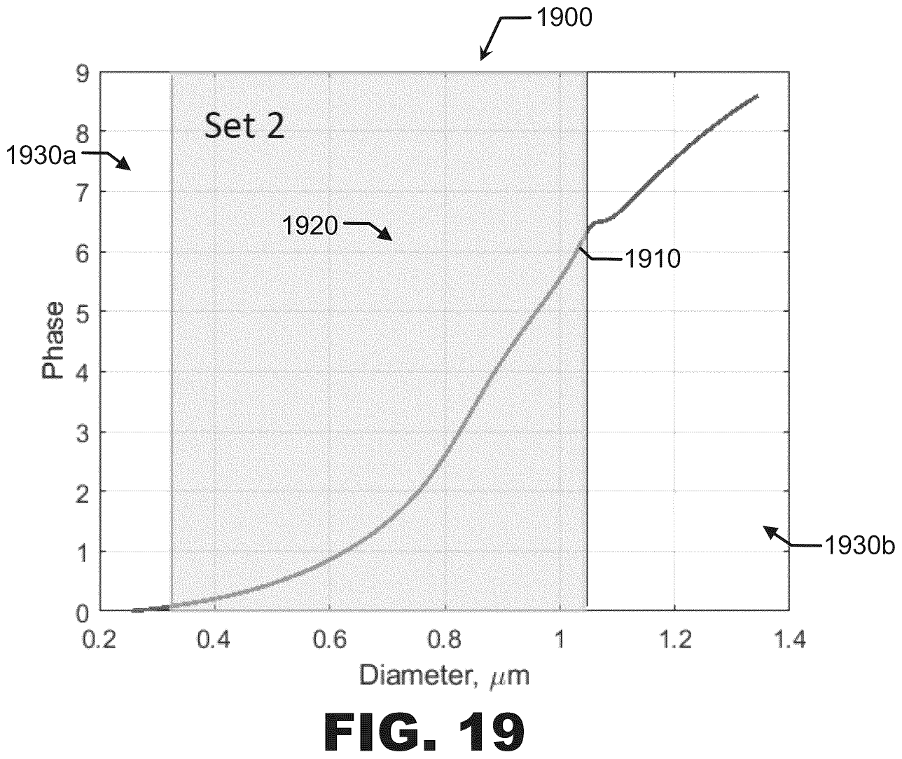

FIG. 17 is a chart 1700 illustrating different focal shifts as a function of library choice for controlled +ΔT from 293 K to 450 K. As shown in FIG. 17, the chart 1700 compares thermally-induced focal-shift data 1710 for a theoretical lens with (i) focal-shift data 1720 for a standard Fresnel lens and (ii) focal-shift data 1730, 1740 for two different metalenses manufactured using different library sets (denoted in FIG. 17 as library set 1 and library set 2). For this particular comparison, the f-number (a measure of a lens' aperture defined as the lens' focal length divided by the lens' aperture diameter) was fixed to f/10 and two different pillar diameters were used for the metalens focal-shift data 1730, 1740. The set 1 and set 2 libraries are shown in FIGS. 18 and 19. Specifically, FIG. 18 shows a chart 1800 having a function 1810 relating phase to diameter for set 1 (1730, FIG. 17), with a library of pillar nanoelements 1820 that are used for set 1 shown as a shaded area and the diameters outside of the library shown as unshaded areas 1830a, 1830b. Likewise, FIG. 19 shows a chart 1900 having another function 1910 relating phase to diameter for set 2 (1740, FIG. 17), with a library of pillar nanoelements 1920 that are used for set 2 shown in as a shaded area and the diameters outside of the library shown as unshaded areas 1930a, 1930b.

From FIGS. 17, 18, and 19, a reduction in Fresnel zones (and consequently, a reduction in lens diameter) shows a deviation of the Fresnel lens 1720 from the theoretical 1710. This deviation is based on lateral expansion, with the curves moving toward negative values associated with the thermal response of a refractive lens. Similar tendencies are observed in both metalenses 1730, 1740. In contrast with standard refractive lenses, the amount of shift is controlled in the metalenses 1730, 1740 by the library set employed in constructing the metalenses 1820, 1920. The range of focal shift is demonstrated by the difference between set 1 (1730, FIG. 17) and set 2 (1740, FIG. 17).

Additionally, from FIG. 17, a configuration for a Fresnel lens 1720 is shown in which focal-shift dependence on the number of Fresnel zones intersects at a zero (0) focal shift (shown by a circle near 1.75 millimeter (mm) diameter on the standard Fresnel curve 1720). That zero point represents a balance between refractive thermal behavior and diffractive thermal behavior, thereby providing the point at which there is no focal shift for that particular temperature change.

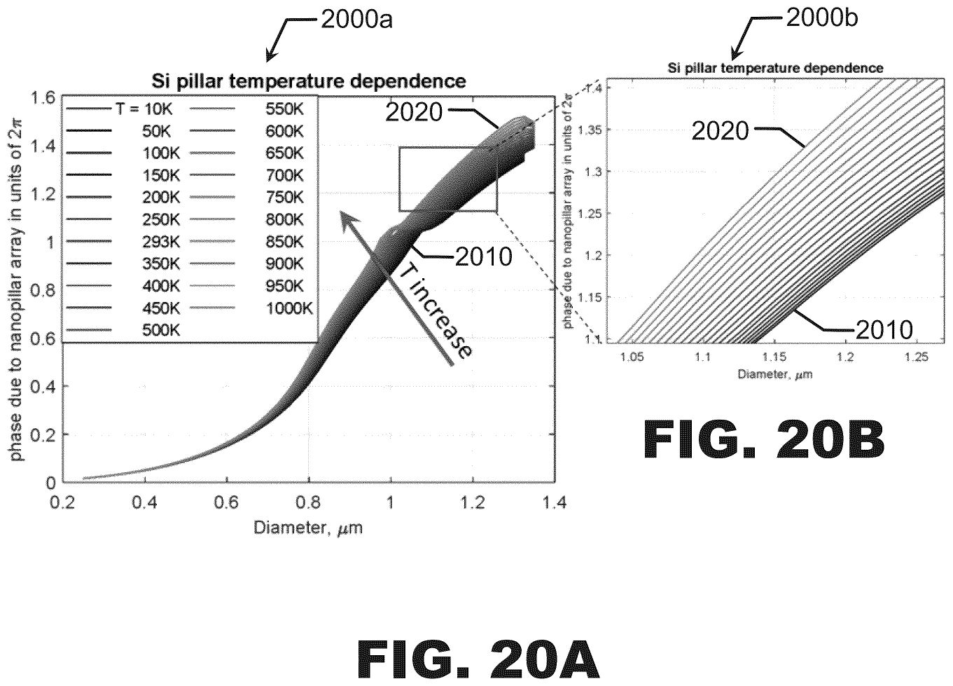

Unlike the Fresnel lens configuration 1720, the metalens configurations 1730, 1740 exhibit qualitatively different behaviors, depending on the library chosen. For example, set 1 (1820, FIG. 18) exhibits a predominantly linear positive slope 1810, while set 2 (1920, FIG. 19) exhibits a predominantly concave-upward non-linear increasing slope 1910. Modification of the libraries of FIGS. 18 and 19 as a function of temperature are shown in FIGS. 20A and 20B.

Specifically, FIG. 20A is a chart 2000a illustrating a T-dependent family of curves for different pillar diameters, while FIG. 20B shows an enlarged portion 2000b of the chart of FIG. 20A. The family of curves progresses from a lower-temperature curve 2010 (at the bottom) to a higher-temperature curve 2020 (at the top). As shown in FIGS. 20A and 20B, for a given temperature increase, a particular combination of curvature (or concavity) and slope results in a larger thermally induced ϕ shift for larger-diameter elements in comparison to smaller-diameter elements. This difference in phase variation with T between larger elements and smaller elements increases when moving toward smaller-diameter elements. For example, using the annotation of FIG. 7, the difference between Δϕ_{L} and Δϕₛₘ increases for smaller-diameter elements—i.e., the phase difference increases. Further, where the library exhibits a negative curvature (e.g., at transition from set 1 to set 2 in the diameter range), the Δϕ with ΔT increases as diameter decreases.

Thus, a zero focal shift can be obtained across an entire range of lens diameters from 2.75 mm to 3.75 mm by gradually shifting pillar diameters from set 1 to set 2. Alternatively, for a given metalens diameter, the amount of focal shift can be varied within a desired range by controlled shifting of the pillar diameter range from set 1 to set 2. Moreover, within that same range of lens diameters (e.g., 2.75 mm to 3.75 mm), thermally induced focal shifts can be varied between positive values and negative values when shifting from set 1 to set 2, thereby providing flexibility in tuning the slope of the focal shift's T-dependence by judicious selection of the library of elements.

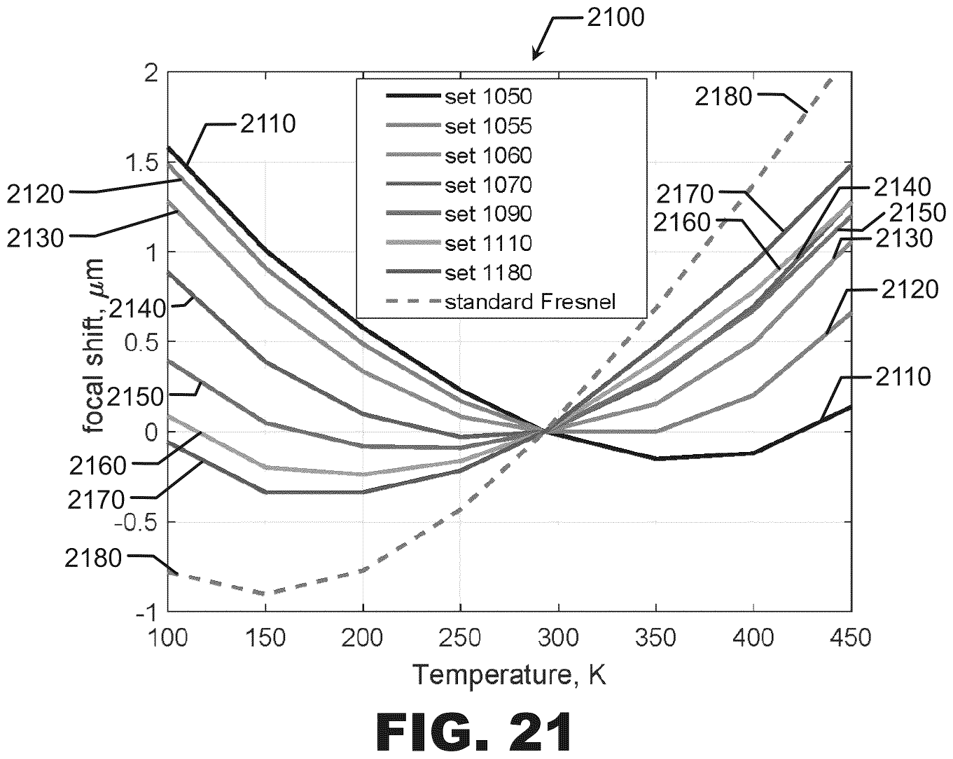

Such a controlled or tunable T-dependent focal shift is shown in FIG. 21, which has a chart 2100 illustrating focal shift as a function of T (both increasing and decreasing from 293 K) for a metalens with an 1 mm diameter, an f-number of three (f/3), a matched wavefront at 4 micrometers (μm), and constructed with pillars having different maximum pillar diameters. A matched wavefront at 4 μm means that the metalens shown in FIG. 21 is optimized for best performance at an incident light wavelength of 4 μm. This also means that the metalens would still function at wavelengths slightly above and below 4 μm, but with reduced efficiency. In this context, 4 μm can be considered the center of metalens' spectral operating range. Specifically, FIG. 21 shows T-dependent focal shift curves for metalenses that are manufactured from library sets having, respectively, maximum pillar diameters of 1050 nm (denoted herein as set 1050) 2110, 1055 nm (set 1055) 2120, 1060 nm (set 1060) 2130, 1070 nm (set 1070) 2140, 1090 nm (set 1090) 2150, 1110 nm (set 1110) 2160, and 1180 nm (set 1180) 2170. For comparison, a T-dependent focal-shift-curve 2180 is also shown in FIG. 21.

As the pillar diameter reduces, the range in the library shifts toward more-negative curvatures. The shift in the library makes the @ profile more convex with +ΔT and less convex with −ΔT, thereby permitting counterbalancing effects of lateral thermal expansion. Consequently, the slope of the T-dependent focal shift gradually changes from positive to negative in the vicinity of 293 K. Also, as shown in FIG. 21, as the pillar library progresses from set 1180 to set 1050, the region of negative curvature shifts correspondingly.

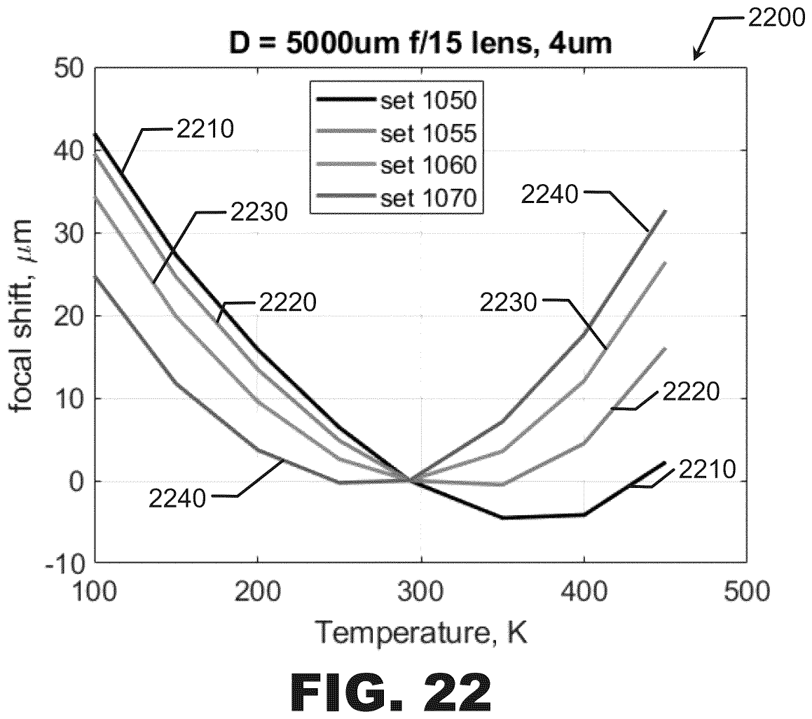

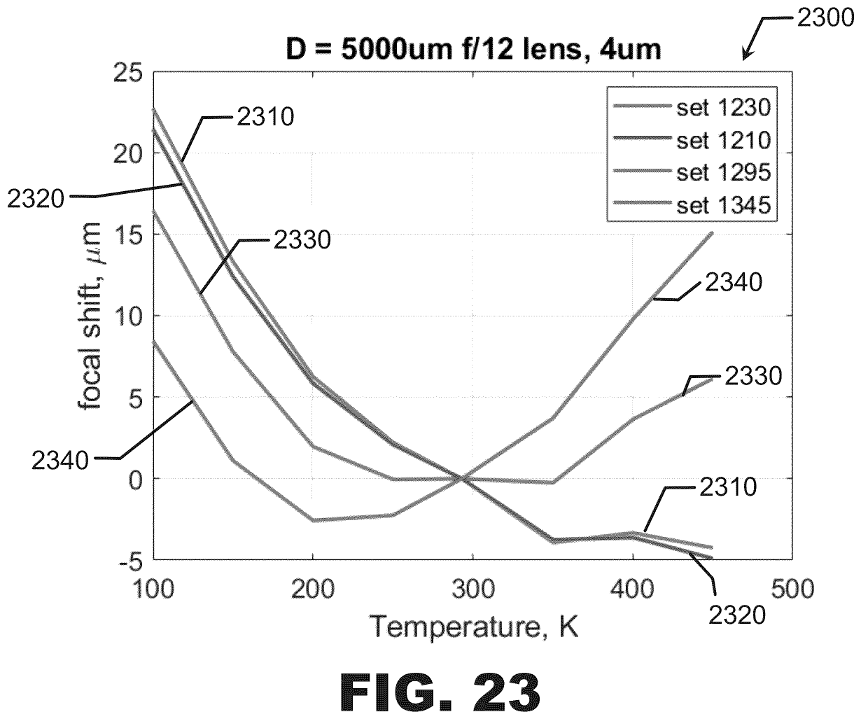

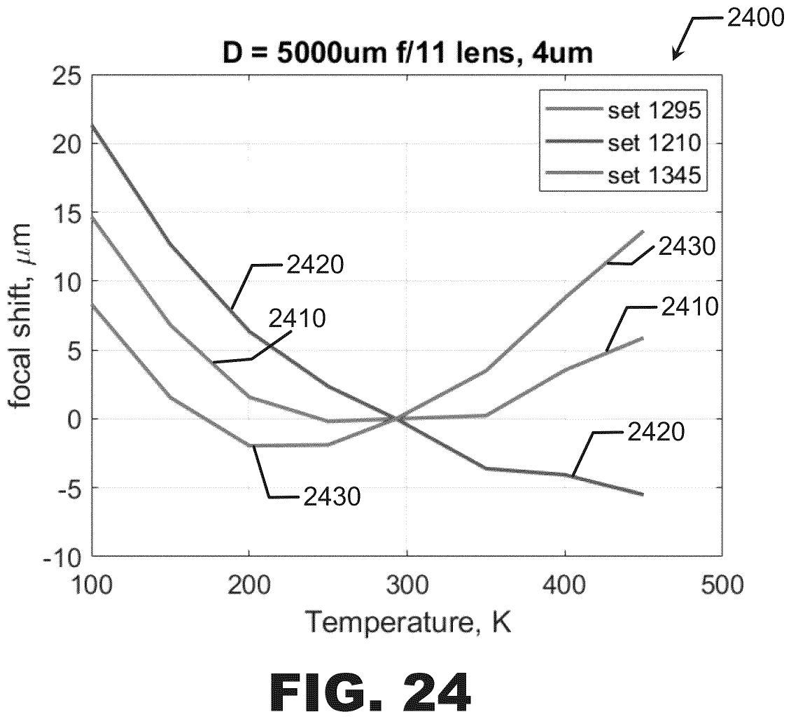

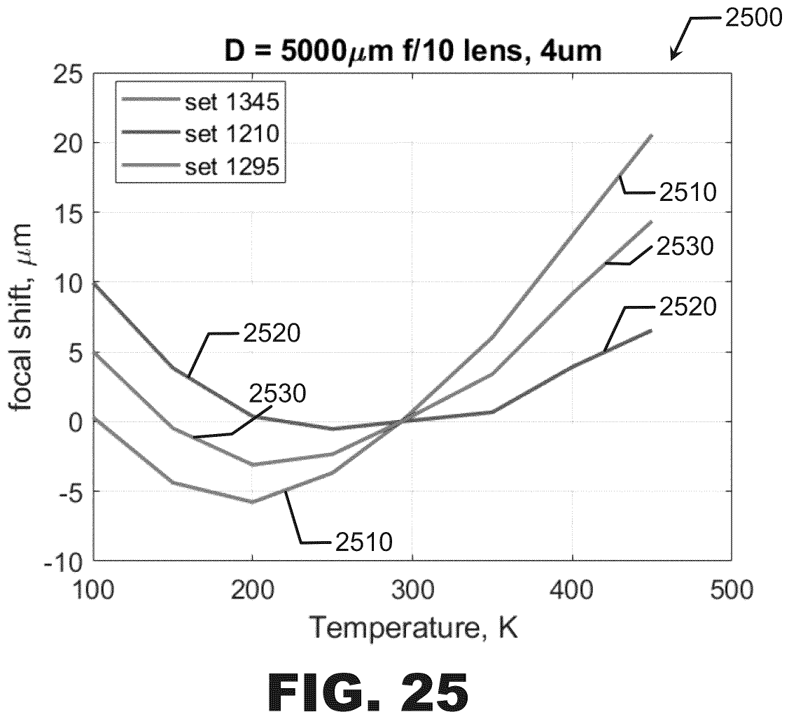

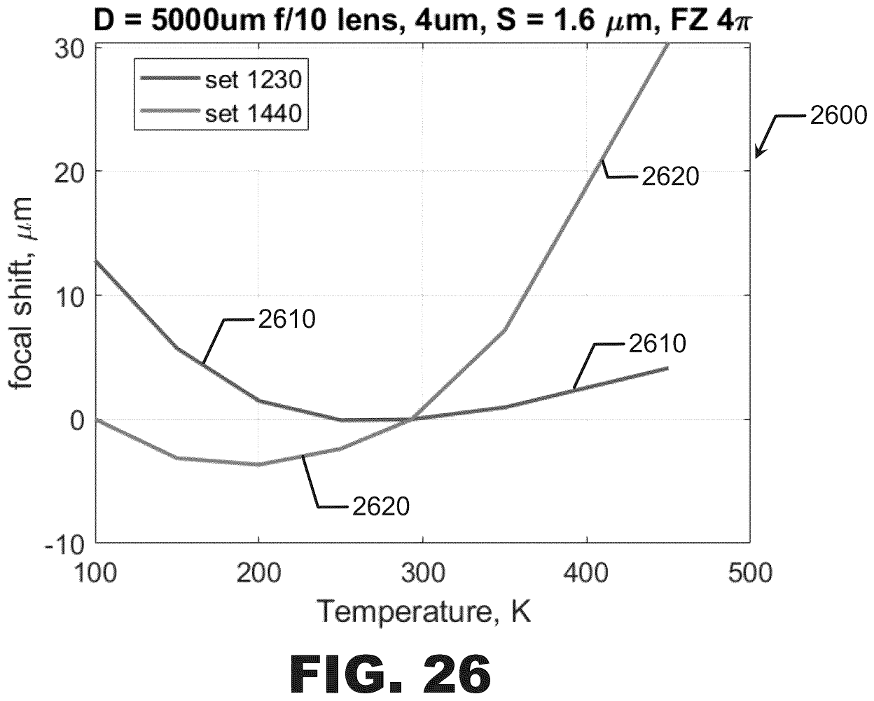

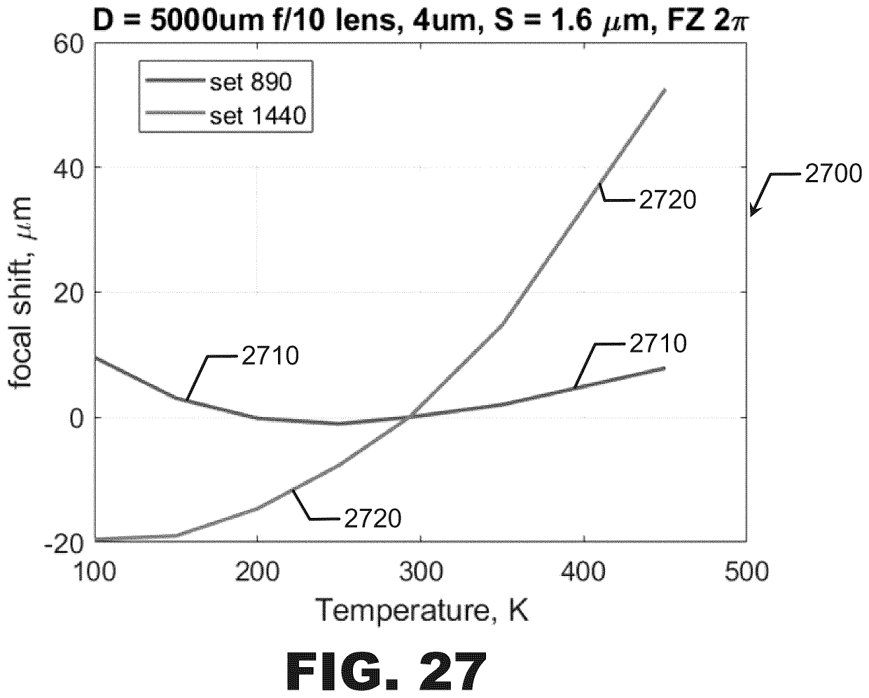

T-dependent tunability of focal distance is shown for different configurations with reference to FIGS. 22, 23, 24, 25, 26, and 27. Specifically, FIG. 22 is a chart 2200 illustrating focal shift as a function of T (both increasing (+ΔT) and decreasing (−ΔT) from 293 K) for a metalens with a 5 mm diameter, f/15, matched wavefront at 4 μm, and constructed with pillars having maximum pillar diameters of 1050 nm (set 1050) 2210, 1055 nm (set 1055) 2220, 1060 nm (set 1060) 2230, and 1070 nm (set 1070) 2240; FIG. 23 is a chart 2300 illustrating focal shift as a function of T (both +ΔT and −ΔT from 293 K) for a metalens with a 5 mm diameter, f/12, matched wavefront at 4 μm, a pitch of 1.5 μm, and constructed with pillars spanning a ϕ range of 4π and having maximum pillar diameters of 1230 nm (set 1230) 2310, 1210 nm (set 1210) 2320, 1295 nm (set 1295) 2330, and 1345 nm (set 1345) 2340; FIG. 24 is a chart 2400 illustrating focal shift as a function of T (both +ΔT and −ΔT from 293 K) for a metalens with a 5 mm diameter, f/11, matched wavefront at 4 μm, a pitch of 1.5 μm, and constructed with pillars spanning a ϕ range of 4π and having maximum pillar diameters of 1295 nm (set 1295) 2410, 1210 nm (set 1210) 2420, and 1345 nm (set 1345) 2430; FIG. 25 is a chart 2500 illustrating focal shift as a function of T (both +ΔT and −ΔT from 293 K) for a metalens with a 5 mm diameter, f/10, matched wavefront at 4 μm, a pitch of 1.5 μm, and constructed with pillars spanning a ϕ range of 4π and having maximum pillar diameters of 1345 nm (set 1345) 2510, 1210 nm (set 1210) 2520, and 1295 nm (set 1295) 2530; FIG. 26 is a chart 2600 illustrating focal shift as a function of both +ΔT and −ΔT from 293K for a metalens with a 5 mm diameter, f/10, matched wavefront at 4 μm, a pitch of 1.6 μm, and constructed with pillars spanning a ϕ range of 4π and having maximum pillar diameters of 1230 nm (set 1230) 2610 and 1440 (set 1440) 2620; and FIG. 27 is a chart 2700 illustrating focal shift as a function of T (both +ΔT and −ΔT from 293K) for a metalens with a 5 mm diameter, f/10, matched wavefront at 4 μm, a pitch of 1.6 μm, and constructed with pillars spanning a ϕ range of 2π and having maximum pillar diameters of 890 nm (set 890) 2710 and 1440 nm (set 1440) 2720. FIGS. 22 through 27 demonstrate how focal distances can be tuned as a function of metalens diameter, f-number, pitch, ϕ range, and pillar diameters.

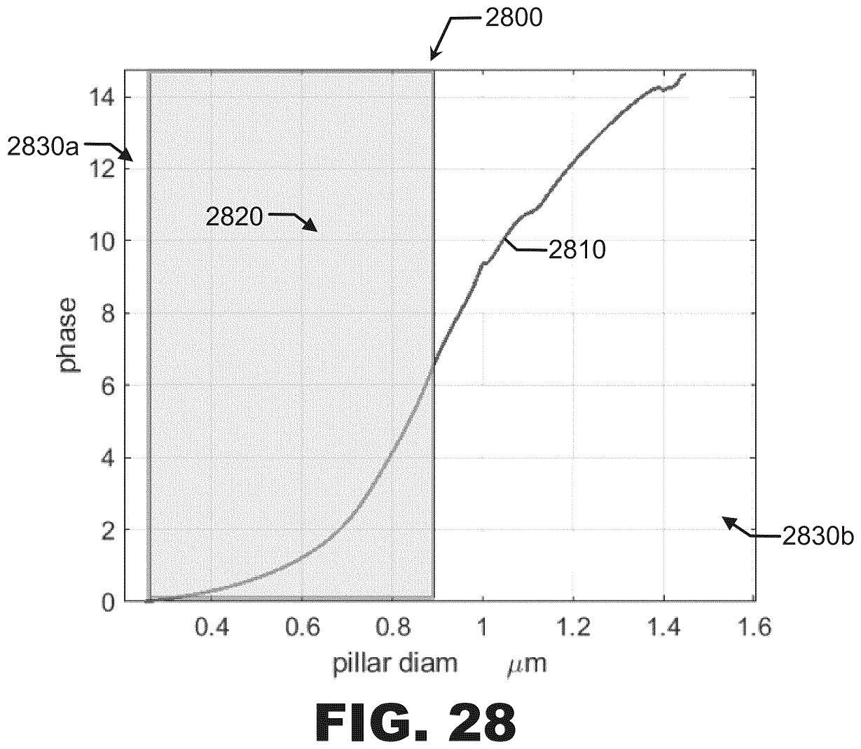

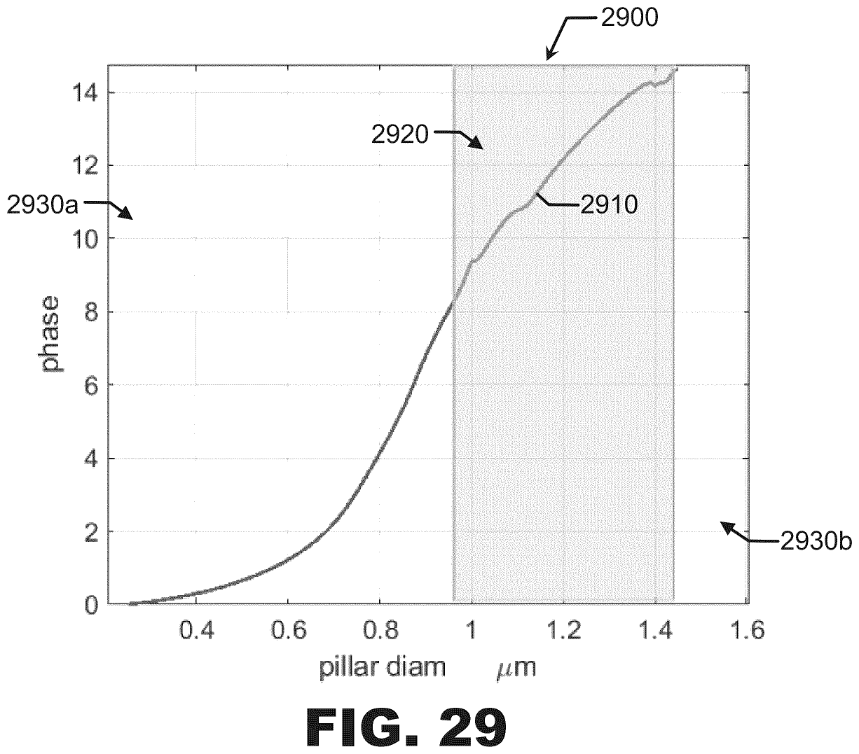

For illustrative purposes and to more-clearly explain the tunability of focal positions, attention is turned to FIG. 27 which compares set 890 (represented by line 2710) and set 1440 (represented by line 2720) for a 5 mm diameter metalens with f/10, 4 μm matched wavefront, 1.6 μm pitch, and 2ϕ ϕ range. FIG. 28 is a chart 2800 illustrating a function 2810 relating phase to diameter for set 890 (2710, FIG. 27), with a library of pillar elements 2820 used for set 890 shown as a shaded area and the diameters outside the library shown as unshaded areas 2830a and 2830b. Similarly, FIG. 29 is a chart 2900 illustrating a function 2910 relating phase to diameter for set 1440 (2720, FIG. 27), with a library of pillar elements 2920 used for set 1440 shown as a shaded area and the diameters outside the library shown as unshaded areas 2930a and 2930b. As one can appreciate from FIG. 27, the T-dependent focal shift is different between set 890 (2710, FIG. 27) and set 1440 (2720, FIG. 27). This is because in FIG. 28, set 890 is characterized by a concave-upward portion of the function 2810 as the pillar diameter increases for the library of pillar elements 2820; while in FIG. 29, set −1440 is characterized by a concave-downward portion of the function 2910 as the pillar diameter increases for the library of pillar elements 2920.

Consequently, and as shown in FIG. 27, for a ΔT between 190 K and 320 K, set 890 (represented by line 2710) exhibits little T-dependency, while set 1440 exhibits substantial T-dependency. Accordingly, if a T-immune metalens is desirable within the above temperature range (e.g., for a ΔT between 190 K and 320 K), set 890 is a better choice than set 1440. Conversely, if a T-dependent tunable metalens is desirable, then set 1440 is a better choice than set 890. Furthermore, if the metalens is mounted in a housing that exhibits a decreasing focal shift with increasing T, then set 1440 can mitigate the housing-related focal shift more than set 890. In other words, depending on the desired behavior of the focal position, and depending on environmental factors that affect the focal position, different libraries of elements can be selected to achieve the desired outcome.

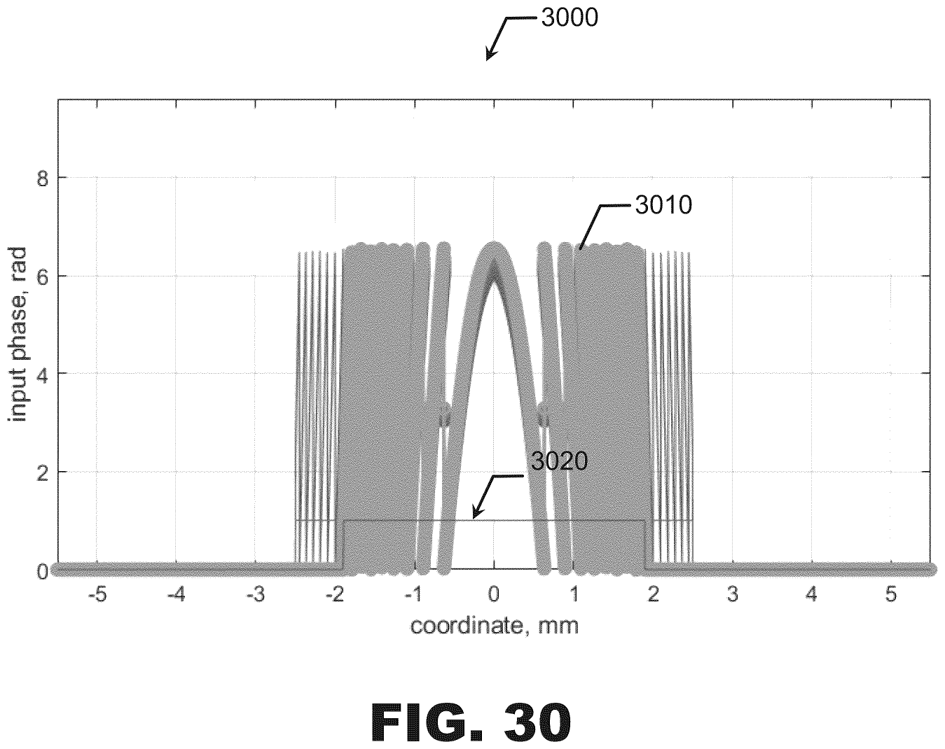

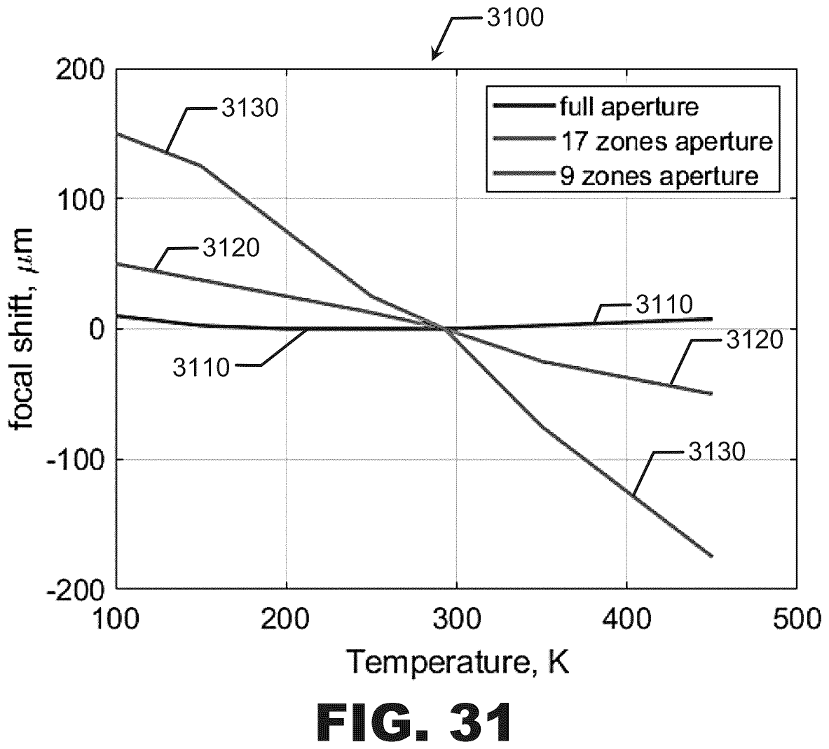

FIG. 30 depicts the phase profile of a 5 mm diameter Si metalens with the design focal length of 50 mm. The phase profile is wrapped to not exceed the range of 2π. Each 2π variation thus forms a separate Fresnel zone. FIG. 30 illustrates that placing an aperture of a smaller size, for example the one shown by the line 3020, reduces the amount of Fresnel zones interacting with the beam passing through the metalens. This illustration will be helpful in understanding FIG. 31.

The chart 3100 of FIG. 31 illustrates the focal shift as a function of temperature T for set 890 (discussed in connection to FIG. 27 above) for (i) full aperture 3110 (here, the full aperture refers to the unrestricted lens diameter shown in FIG. 30, spanning from −2.5 mm to 2.5 mm and encompassing all 33 Fresnel zones of the phase profile), (ii) 17 Fresnel aperture zones 3120 (the 17 Fresnel zones aperture is shown by the line 3020 in FIG. 30, stretching from approximately −2 mm to approximately 2 mm), and (iii) 9 Fresnel aperture zones 3130. In FIG. 31, set 3110 reproduces set 2710 (representing set 890) shown earlier in FIG. 27. This set exhibits a decreasing focal shift for the whole range of T between 100 K and 450 K. However, restricting the aperture to 17 Fresnel zones and further to 9 Fresnel zones, drastically changes the slope of the focal shift versus temperature dependence, as seen in sets 3120 and 3130 in FIG. 31, respectively. This variation in slope occurs because of the increasing impact of thermal lateral expansion when increasing the metalens diameter and, as a consequence, increasing the amount of Fresnel zones. Note that the slope becomes increasingly negative when reducing the metalens diameter, thus shifting it further away from the positive slope of an equivalent standard Fresnel lens. The illustration in FIG. 31 serves to demonstrate two points. First, careful selection of a combination of Fresnel zones and pillar diameters permits yet another degree of T-dependent control in metalenses. Second, increasing the metalens diameter—e.g., progressing from set 3130 to set 3120 to set 3110 in FIG. 31—renders it more challenging to compensate for the positive slope of the focal shift versus temperature dependence observed in standard Fresnel lenses, due to the increased impact of lateral expansion. Nevertheless, the proposed approach demonstrates the capability to reduce this slope to near-zero values for metalenses with diameters of at least up to 5 mm.

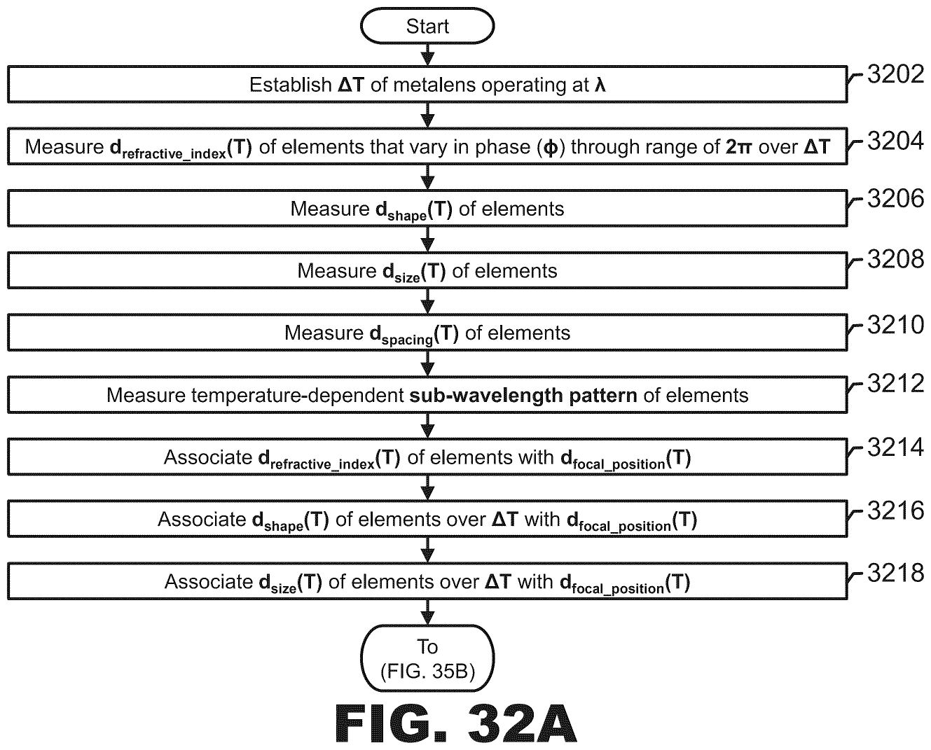

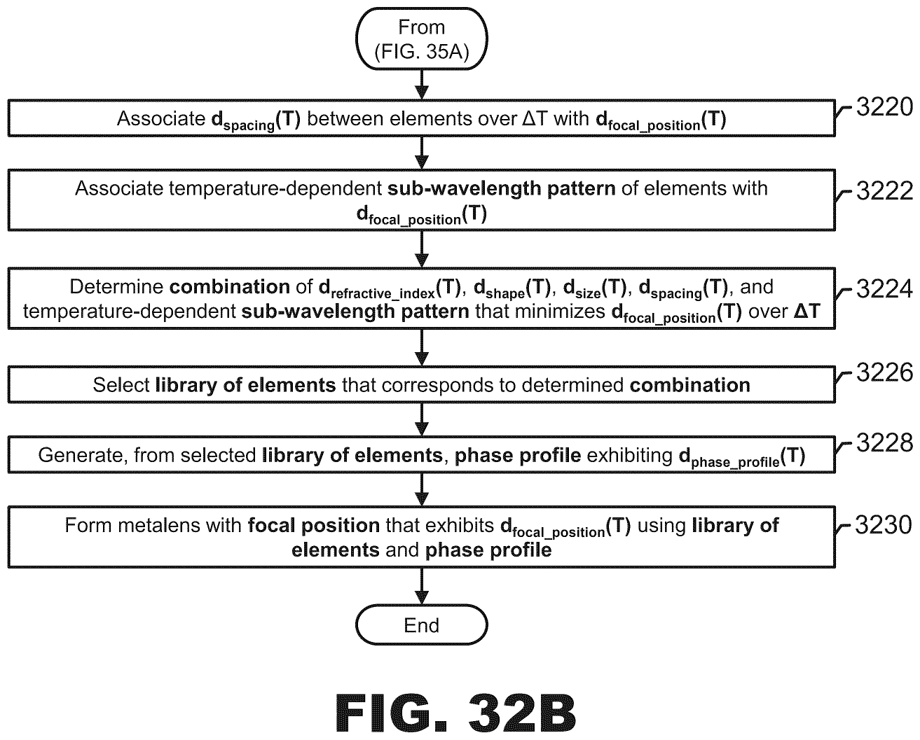

According to some embodiments, FIGS. 32A and 32B describe a process for the fabrication of a metalens that exhibits a desirable temperature-dependent focal length via an appropriate selection of a library of elements and their phase profile. The light to be focused by the manufactured metalens is characterized by a center wavelength (λ) and a propagating phase (ϕ). The process begins at step 3202 where an operating temperature range (ΔT) is first established. For the established ΔT, the process measures at step 3204 temperature-dependent changes in refractive indices (d_{refractive_index}(T)). As discussed above, the elements have a varying ϕ through a range of 2π radians over the ΔT. The process further measures, at step 3206, temperature-dependent changes in the shapes (dₛₕₐₚₑ(T)) of the elements over the ΔT, and at step 3208, temperature-dependent changes in the sizes (d_{size}(T)) of the elements over the ΔT. At step 3210, temperature-dependent changes in the spacings (d_{spacing}(T)) between the elements over the ΔT are measured. This is important because the slope of the phase versus the pillar diameter curve (shown, for example, in FIGS. 18 and 19 for library of element 1820 and 1920, as well as for any other library of elements) depends on the spacing between library elements having the same range of diameters. Therefore, when the spacing changes due to temperature, the dependency of the phase versus diameter also changes. Accordingly, d_{spacing}(T) can be used as one of the control mechanisms in designing thermally stable metalenses or in controlling the slope of the focal shift versus temperature.

As discussed, the phase profile imposed by a metalens on the incident beam of light is created by arranging nanoelements (in this case, pillars) of various sizes on a surface.

When the temperature changes, this arrangement of nanoelements undergoes lateral expansion or contraction. In step 3212, a temperature-dependent sub-wavelength pattern of the elements over the ΔT is determined. That is, the new positions of all the elements in the metasurface are determined as a function of their coordinates, accounting for the shifts caused by lateral expansion. These position changes, in addition to any modifications caused by the processes described in steps 3204 through 3210, modify the phase profile imposed by the metasurface.

Once these parameters are measured in respective steps 3202, 3204, 3206, 3208, 3210, 3212, the process associates in step 3214 the d_{refractive_index}(T) with temperature-dependent changes in a focal position (d_{focal_position}(T)) over the ΔT. The process further associates dₛₕₐₚₑ(T) with d_{focal_position}(T) over the ΔT (step 3216), and d_{size}(T) with d_{focal_position}(T) (step 3218).

The process then proceeds to step 3220 in FIG. 32B where the process associates d_{spacing}(T) with d_{focal_position}(T) and the temperature-dependent sub-wavelength pattern of the elements with d_{focal_position}(T) (step 3222).

Upon measuring the relevant parameters in steps 3202, 3204, 3206, 3208, 3210, 3212 and associating those parameters with d_{focal_position}(T) as described in steps 3214, 3216, 3218, 3220, 3222, the process determines in step 3224 a combination of the d_{refractive_index}(T), the dₛₕₐₚₑ(T), the d_{size}(T), the d_{spacing}(T), and the temperature-dependent sub-wavelength pattern that minimizes d_{focal_position}(T) over the ΔT. Thereafter, the process selects in step 3226 a library of elements that corresponds to the combination determined in step 3224, and generates in step 3228 a phase profile from the selected library of elements. The phase profile exhibits temperature-dependent phase-profile changes (d_{phase_profile}(T)) over the ΔT. From the generated phase profile (step 3228) and the selected library of elements (step 3226), the process forms in step 3230 a metalens with a focal position that exhibits a desired d_{focal_position}(T) over the ΔT.

As shown from the embodiments of FIGS. 1 through 32B, the metalens and the process for manufacturing the metalens are neither trivial nor predictable, as there are many different factors (e.g., d_{refractive_index}(T), the dₛₕₐₚₑ(T), the d_{size}(T), the d_{spacing}(T), and the temperature-dependent sub-wavelength pattern) that sometimes act in concert to enlarge a focal distance and sometimes act against each other to maintain a fixed focal distance. Nevertheless, the disclosure herein teaches how different parameters are measured and then associated with T-dependent focal position to construct a tunable T-dependent metalens.

### Some Embodiments

Some embodiments may include any of the following:

A1. A metalens for focusing light, the light includes a center wavelength and a propagating phase. The metalens includes a library of elements for varying the propagating phase of the focusing light over a range of at least 2π radians, where the library of elements is arranged in a sub-wavelength pattern that defines spacings between the elements. Each spacing exhibiting temperature-dependent spacing changes within temperature range and where each element in the library of elements includes: a refractive index exhibiting a temperature-dependent refractive-index change within the temperature range, a shape exhibiting a temperature-dependent shape change within the temperature range, and a size exhibiting a temperature-dependent size change within the temperature range. The metalens also includes a phase profile defined by a combination of the refractive index, shape, and size of each element in the library of elements, and the sub-wavelength pattern of the library of elements. The metalens also includes a focal length defined by the phase profile, the focal length exhibiting temperature-dependent focal-length changes within the temperature range.

A2. The metals of clause A1 can include any of the following components or features, in any combination. The size of each element is smaller than the center wavelength. The spacing between the elements in the sub-wavelength pattern is smaller than the center wavelength. The library of elements, as arranged within the sub-wavelength pattern, collectively produce a phase profile that minimizes a variation of the focal length of the metalens within the temperature range. The library of elements, as arranged within the sub-wavelength pattern, collectively produce a phase profile that tunes the focal length of the metalens within the temperature range. The elements in the library of elements are pillar-shaped with a maximum pillar diameter between 1050 nm and 1180 nm. The temperature-dependent focal-length change is varied between positive and negative values or between negative and positive values by gradually changing the maximum pillar diameter of the elements within the sub-wavelength pattern. The library of elements vary the propagating phase of the focusing light within 4π radians. The metalens has a diameter of 5 millimeters (mm). A behavior of the focal length within the temperature range is controlled by which elements are included in the library of elements, the refractive index, shape, and size of each included element, the sub-wavelength pattern of the elements, and the phase profile produced by a combination thereof. A zero temperature-dependent focal-length change is achieved by gradually shifting a diameter of the elements within the sub-wavelength pattern.

A3. A process for selecting elements for a metalens that exhibits a temperature-dependent focal length within an operating temperature range. The process includes obtaining candidate elements, each set of elements configured to vary a propagating phase of refracted light over a range of at least 2π radians, measuring a refractive index change of each element over the operating temperature range, measuring a shape change of each element over the operating temperature range, measuring a size change of each element over the operating temperature range, and measuring a spacing change between elements over the operating temperature range for elements arranged within a sub-wavelength pattern. The process further includes in a first step, calculating a focal length shift of the metalens caused by the measured refractive index change over the operating temperature range, in a second step, calculating the focal length shift of the metalens caused by the measured shape change over the operating temperature range, in a third step, calculating the focal length shift of the metalens caused by the measured size change over the operating temperature range, and in a fourth step, calculating the focal length shift of the metalens caused by the measured spacing change over the operating temperature range. Additionally, the process includes determining a combination of elements that causes the focal length shift of the metalens to change in a predictable way over the operating temperature range, where the determination is based at least on the first, second, third, and fourth step, and finally selecting a library of elements that form the metalens based on the determined combination.

The process of clause A3 can include any of the following components or features, in any combination. The process may also include based on the selected library of elements, generating a phase profile for the metalens, over the operating temperature range; and forming the metalens from the library of elements based on the generated phase profile, where determining the combination of elements further comprises identifying a curvature of the phase profile as a function of element parameters to achieve a desired focal length shift of the metalens, the element parameters comprising element size. The formed metalens exhibits zero focal length shift over the operating temperature. The formed metalens exhibits a positive focal length shift over the operating temperature. The formed metalens exhibits a negative focal length shift over the operating temperature. The process where selecting the library of elements comprises selecting a sub-group of the candidate elements. The process where selecting the library of elements comprises arranging the elements in a sub-wavelength pattern that produces a phase profile for the metalens that changes over the operating temperature range. Each set of elements is configured to vary the propagating phase of the transmitted light over a range of 4π radians. The process where obtaining the candidate elements comprises selecting elements whose size is smaller than a center wavelength of the refracted light.

### ADDITIONAL CONSIDERATIONS

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Implementations of the subject matter and the operations described in this specification, such as those described in connection to FIGS. 32A and 32B, can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification, such as those described in connection to FIGS. 32A and 32B, can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art.

In some embodiments, aspects of the systems and methods described herein may be implemented using ML and/or AI technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A metalens for focusing light, the light comprising a center wavelength and a propagating phase, the metalens comprising:
a library of elements for varying the propagating phase of the focusing light over a range of at least 2π radians, wherein the library of elements is arranged in a sub-wavelength pattern that defines spacings between the elements, with each spacing exhibiting temperature-dependent spacing changes within temperature range, wherein each element in the library of elements comprising:
a refractive index exhibiting a temperature-dependent refractive-index change within the temperature range;
a shape exhibiting a temperature-dependent shape change within the temperature range; and
a size exhibiting a temperature-dependent size change within the temperature range;
a phase profile defined by a combination of the refractive index, shape, and size of each element in the library of elements, and the sub-wavelength pattern of the library of elements; and
a focal length defined by the phase profile, the focal length exhibiting temperature-dependent focal-length changes within the temperature range.

2. The metalens of claim 1, wherein the size of each element is smaller than the center wavelength.

3. The metalens of claim 1, wherein the spacing between the elements in the sub-wavelength pattern is smaller than the center wavelength.

4. The metalens of claim 1, wherein the library of elements, as arranged within the sub-wavelength pattern, collectively produce a phase profile that minimizes a variation of the focal length of the metalens within the temperature range.

5. The metalens of claim 1, wherein the library of elements, as arranged within the sub-wavelength pattern, collectively produce a phase profile that tunes the focal length of the metalens within the temperature range.

6. The metalens of claim 1, wherein the elements in the library of elements are pillar-shaped with a maximum pillar diameter between 1050 nm and 1180 nm.

7. The metalens of claim 6, wherein the temperature-dependent focal-length change is varied between positive and negative values or between negative and positive values by gradually changing the maximum pillar diameter of the elements within the sub-wavelength pattern.

8. The metalens of claim 1, wherein the library of elements vary the propagating phase of the focusing light within 4π radians.

9. The metalens of claim 1, wherein the metalens has a diameter of 5 millimeters (mm).

10. The metalens of claim 1, wherein a behavior of the focal length within the temperature range is controlled by which elements are included in the library of elements, the refractive index, shape, and size of each included element, the sub-wavelength pattern of the elements, and the phase profile produced by a combination thereof.

11. The metalens of claim 1, wherein a zero temperature-dependent focal-length change is achieved by gradually shifting a diameter of the elements within the sub-wavelength pattern.

12. A process for selecting elements for a metalens that exhibits a temperature-dependent focal length within an operating temperature range, the process comprising:
obtaining candidate elements, each set of elements configured to vary a propagating phase of refracted light over a range of at least 2π radians;
measuring a refractive index change of each element over the operating temperature range;
measuring a shape change of each element over the operating temperature range;
measuring a size change of each element over the operating temperature range;
measuring a spacing change between elements over the operating temperature range for elements arranged within a sub-wavelength pattern;
in a first step, calculating a focal length shift of the metalens caused by the measured refractive index change over the operating temperature range;
in a second step, calculating the focal length shift of the metalens caused by the measured shape change over the operating temperature range;
in a third step, calculating the focal length shift of the metalens caused by the measured size change over the operating temperature range;
in a fourth step, calculating the focal length shift of the metalens caused by the measured spacing change over the operating temperature range;
determining a combination of elements that causes the focal length shift of the metalens to change in a predictable way over the operating temperature range, wherein the determination is based at least on the first, second, third, and fourth step; and
selecting a library of elements that form the metalens based on the determined combination.

13. The process of claim 12, further comprising:
based on the selected library of elements, generating a phase profile for the metalens, over the operating temperature range; and
forming the metalens from the library of elements based on the generated phase profile, wherein determining the combination of elements further comprises identifying a curvature of the phase profile as a function of element parameters to achieve a desired focal length shift of the metalens, the element parameters comprising element size.

14. The process of claim 13, wherein the formed metalens exhibits zero focal length shift over the operating temperature.

15. The process of claim 13, wherein the formed metalens exhibits a positive focal length shift over the operating temperature.

16. The process of claim 13, wherein the formed metalens exhibits a negative focal length shift over the operating temperature.

17. The process of claim 12, wherein selecting the library of elements comprises selecting a sub-group of the candidate elements.

18. The process of claim 12, wherein selecting the library of elements comprises arranging the elements in a sub-wavelength pattern that produces a phase profile for the metalens that changes over the operating temperature range.

19. The process of claim 12, wherein each set of elements is configured to vary the propagating phase of the transmitted light over a range of 4π radians.

20. The process of claim 12, wherein obtaining the candidate elements comprises selecting elements whose size is smaller than a center wavelength of the refracted light.
